(19) United States
(12) Patent Application Publication
(10) Pub. No.: US 2026/0001244 A1
(43) Pub. Date: Jan. 1, 2026

(54) MULTI-FUNCTIONAL KNIFE

(71) Applicant: NINGBO XINGWEI CUTTING-TOOLS TECHNOLOGY CO., LTD., Ningbo (CN)

(72) Inventors: Mingxiang Pan, Ningbo (CN); Yuancheng Ye, Ningbo (CN)

(73) Assignee: NINGBO XINGWEI CUTTING-TOOLS TECHNOLOGY CO., LTD., Ningbo, ZJ (CN)

(21) Appl. No.: 18/878,662

(22) PCT Filed: Feb. 5, 2024
(86) PCT No.: PCT/CN2024/075931

§ 371 Date: Dec. 24, 2024

(30) Foreign Application Priority Data
Dec. 22, 2023 (CN) 202311787417.2
Jan. 22, 2024 (CN) 202410089192.1
Jan. 22, 2024 (CN) 202410092612.1

(51) Int. Cl. B26B 5/00; B26B 11/00

(52) U.S. Cl. CPC B26B 5/003; B26B 11/006

(57) ABSTRACT

A multi-functional knife is provided, including: a housing provided with an accommodating cavity and an opening, where the opening is provided at a front end of the housing; a blade holder configured to hold a blade and removably accommodated in the accommodating cavity; a first guide assembly including a first guide rail and a drive member which is drivably connected to a front side of the blade holder to cause the blade holder to move along the first guide rail; and a second guide assembly including a fixed surface and a second guide rail provided on the fixed surface. A rear side of the blade holder is pivotally connected to the second guide rail to cause the blade holder to move along the second guide rail.

### CROSS REFERENCE TO THE RELATED APPLICATIONS

This application is the national phase entry of International Application No. PCT/CN2024/075931, filed on Feb. 5, 2024, which is based upon and claims priority to Chinese Patent Application No. 202311787417.2 filed on Dec. 22, 2023, Chinese Patent Application No. 202410089192.1 filed on Jan. 22, 2024, and Chinese Patent Application No. 202410092612.1 filed on Jan. 22, 2024, the entire contents of which are incorporated herein by reference.

### TECHNICAL FIELD

The present disclosure relates to the technical field of knives, and specifically to a multi-functional knife.

### BACKGROUND

Knives are mainly divided into cutter knives for lateral cutting and scraper knives for scraping. Cutter knives are tools for arts and handicrafts. Most cutter knives have a pull-out structure, including a plastic handle and a blade. Generally, the cutting edge of the blade is parallel to the axis of the handle or housing, and is mainly used for cutting, for example, paper, cardboard, etc. A scraper knife generally has a blade perpendicular or orthogonal to the axis of the handle, and is used for scraping, for example, paint, glue marks, etc. from a flat surface. Cutter knives and scraper knives are separate manual tools, and usually cannot be used for each other's purposes. A user usually needs to purchase, store, and carry both the two types of separate tools, which is inconvenient to the user.

Existing multi-functional knives can be transformed between a cutter knife and a scraper knife, but have a complicated structure and are inconvenient to operate.

### SUMMARY

An objective of the present disclosure is to provide a multi-functional knife, which has a compact structure and can be quickly positioned at multiple angles through the movement of a blade holder on a first guide rail and a second guide rail to serve as a cutter knife or a scraper knife, thereby improving the working efficiency.

Another objective of the present disclosure is to provide a multi-functional knife, which has a simple structure and does not require the use of an additional complicated accessory, and in which a movement trajectory of a blade holder is defined by a first guide rail and a second guide rail on a surface of a housing to allow a blade to be smoothly adjusted to a plurality of positioning positions in a range of 0° to 90°, thereby reducing the production costs.

An objective of the present disclosure is to provide a multi-functional folding knife, which has a compact structure and can be quickly positioned at multiple angles through the movement of a blade holder on a first guide rail and a second guide rail to serve as a cutter knife or a scraper knife, thereby improving the working efficiency.

Another objective of the present disclosure is to provide a multi-functional folding knife, in which a first guide member and a second guide member on a blade holder are deflected and guided to an appropriate direction to generate a thrust force to push the blade holder in a rotational direction, in order to cause the blade holder to rotate to a preset position, so that a blade can be used longitudinally, transversely, or obliquely for different purposes, thereby expanding the application range of the knife.

Another objective of the present disclosure is to provide a multi-functional folding knife, in which a safety assembly is used to retain a blade holder in a longitudinal position to prevent the blade holder from accidentally rotating to cause an accidental injury.

Another objective of the present disclosure is to provide a multi-functional folding knife, in which a self-locking assembly is configured such that an inner housing can be rotated and folded to an outer housing when a blade holder is located in a longitudinal position, and the multi-functional folding knife can be kept in an unfolded state when the blade holder is located in other positions, in order to avoid an accidental injury caused by a blade edge being unable to be smoothly accommodated in a main accommodating chamber.

To achieve the above objectives, the following technical solutions are adopted in the present disclosure. A multi-functional knife is provided, including: a housing, where the housing is provided with an accommodating cavity and an opening, and the opening is provided at a front end of the housing; a blade holder, where the blade holder is configured to hold a blade, and is rotatably mounted in the accommodating cavity; a first guide assembly, where the first guide assembly includes a first guide rail and a drive member, and the drive member is drivably connected to a front side of the blade holder to cause the blade holder to move along the first guide rail; and a second guide assembly, where the second guide assembly includes a fixed surface and a second guide rail provided on the fixed surface, and a rear side of the blade holder is pivotally connected to the second guide rail to cause the blade holder to move along the second guide rail, and when the drive member is longitudinally moved along an axial direction relative to the fixed surface, the blade holder is selectively rotated into or out of the accommodating cavity, so that an orientation of the blade holder is changed to a plurality of positioning angles between a longitudinal position and a transverse position alternately.

To achieve the above objectives, the following technical solutions are adopted in the present disclosure. A multi-functional folding knife is provided, including: a housing, where the housing includes an outer housing and an inner housing, the inner housing is rotatably and foldably mounted in the outer housing, and the inner housing is provided with an accommodating cavity and an end opening, and the end opening is provided at a front end of the inner housing; a blade holder, where the blade holder is configured to hold a blade, and is rotatably mounted in the accommodating cavity; a first guide assembly, where the first guide assembly includes a first guide rail and a drive member, and the drive member is drivably connected to a front side of the blade holder to cause the blade holder to move along the first guide rail; and a second guide assembly, where the second guide assembly includes a fixed surface and a second guide rail provided on the fixed surface, and a rear side of the blade holder is pivotally connected to the second guide rail to cause the blade holder to move along the second guide rail, and when the drive member translates and/or rotates relative to the fixed surface, the blade holder is selectively rotated into or out of the accommodating cavity, so that an orientation of the blade holder is changed to a plurality of positioning angles between a longitudinal position and a transverse position alternately.

### BRIEF DESCRIPTION OF THE DRAWINGS

FIG. 1 is a schematic structural diagram of a multi-functional knife in a retracted position according to some embodiments of the present disclosure.

FIG. 2 is a schematic diagram of a multi-functional knife in a retracted position according to some embodiments of the present disclosure.

FIG. 3 is a schematic structural diagram of a multi-functional knife in a first longitudinal position according to some embodiments of the present disclosure.

FIG. 4 is a schematic diagram of a multi-functional knife in a first longitudinal position according to some embodiments of the present disclosure.

FIG. 5 is a schematic structural diagram of a multi-functional knife in a second longitudinal position according to some embodiments of the present disclosure.

FIG. 6 is a schematic diagram of a multi-functional knife in a second longitudinal position according to some embodiments of the present disclosure.

FIG. 7 is a schematic structural diagram of a multi-functional knife in a transitional position according to some embodiments of the present disclosure.

FIG. 8 is a schematic diagram of a multi-functional knife in a transitional position according to some embodiments of the present disclosure.

FIG. 9 is a schematic structural diagram of a multi-functional knife in a transverse position according to some embodiments of the present disclosure.

FIG. 10 is a schematic diagram of a multi-functional knife in a transverse position according to some embodiments of the present disclosure.

FIG. 11 is an exploded view of a multi-functional knife according to some embodiments of the present disclosure.

FIG. 12 is a partial exploded view of a multi-functional knife according to some embodiments of the present disclosure.

FIG. 13 is a structural diagram of an interior of a multi-functional knife according to some embodiments of the present disclosure.

FIG. 14 is a cross-sectional view showing that a stop portion of an anti-rotation member is engaged with a blade holder according to some embodiments of the present disclosure.

FIG. 15 is a cross-sectional view showing that a stop portion of an anti-rotation member is disengaged from a blade holder according to some embodiments of the present disclosure.

FIG. 16 is an exploded view of a blade holder according to some embodiments of the present disclosure.

FIG. 17 is an exploded view of a blade holder according to some embodiments of the present disclosure.

FIG. 18 is a schematic diagram of a multi-functional knife in a retracted position according to some further embodiments of the present disclosure.

FIG. 19 is a schematic structural diagram of a multi-functional folding knife in an unfolded longitudinal position according to some embodiments of the present disclosure.

FIG. 20 is a schematic structural bottom view of a multi-functional folding knife in an unfolded longitudinal position according to some embodiments of the present disclosure.

FIG. 21 is a cross-sectional view of a multi-functional folding knife in an unfolded longitudinal position according to some embodiments of the present disclosure.

FIG. 22 is a schematic structural diagram of a multi-functional folding knife in an unfolded transitional position according to some embodiments of the present disclosure.

FIG. 23 is a schematic structural diagram of a multi-functional folding knife in an unfolded transverse position according to some embodiments of the present disclosure.

FIG. 24 is a schematic structural diagram of a multi-functional folding knife in a folded position according to some embodiments of the present disclosure.

FIG. 25 is a partial exploded view of a multi-functional folding knife according to some embodiments of the present disclosure.

FIG. 26 is a partial exploded view of a multi-functional folding knife according to some embodiments of the present disclosure.

FIG. 27 is a structural diagram of an interior of a multi-functional folding knife according to some embodiments of the present disclosure.

FIG. 28 is a structural diagram of an interior of a multi-functional folding knife according to some embodiments of the present disclosure.

FIG. 29 is a cross-sectional view of a multi-functional folding knife according to some embodiments of the present disclosure.

FIG. 30 is a schematic structural diagram of a safety push button according to some embodiments of the present disclosure.

FIG. 31 is an exploded view of a blade holder according to some embodiments of the present disclosure.

FIG. 32 is an exploded view of a blade holder according to some embodiments of the present disclosure.

FIG. 33 is a schematic diagram of a multi-functional folding knife in a longitudinal position according to some embodiments of the present disclosure.

FIG. 34 is a schematic diagram showing that a multi-functional folding knife is in a longitudinal position and is ready to rotate according to some embodiments of the present disclosure.

FIG. 35 is a schematic diagram of a multi-functional folding knife in a transitional position according to some embodiments of the present disclosure.

FIG. 36 is a schematic diagram of a multi-functional folding knife in a transverse position according to some embodiments of the present disclosure.

### DETAILED DESCRIPTION OF THE EMBODIMENTS

The present disclosure will be further described through specific embodiments. It should be noted that the embodiments or technical features described below may be arbitrarily combined to form new embodiments without conflict.

In the description of the present disclosure, it should be noted that orientation and position relationships indicated by the orientation terms such as “center”, “transverse”, “longitudinal”, “length”, “width”, “thickness”, “on”, “below”, “front”, “rear”, “left”, “right”, “vertical”, “horizontal”, “top”, “bottom”, “inner”, and “outer” are based on the orientation or positional relationships shown in the drawings, and are only for the convenience of describing the present disclosure and simplifying the description, rather than indicating or implying that the apparatus or element described must have a specific orientation or be constructed and operated in a specific orientation, and therefore are not to be construed as limiting the present disclosure.

It should be noted that in the specification and claims of the present disclosure, the terms “first”, “second” or the like are intended to distinguish between similar objects but do not indicate a particular order or sequence.

It should be noted that the terms such as “front side” and “rear side” for indicating the orientation are only for the convenience of describing the present disclosure and simplifying the description, rather than indicating or implying that the apparatus or element described must have a specific orientation or be constructed and operated in a specific orientation, may also be expressed as phrases such as “upper side”, “lower side”, “one side”, and “another side”, and therefore are not to be construed as limiting the present disclosure.

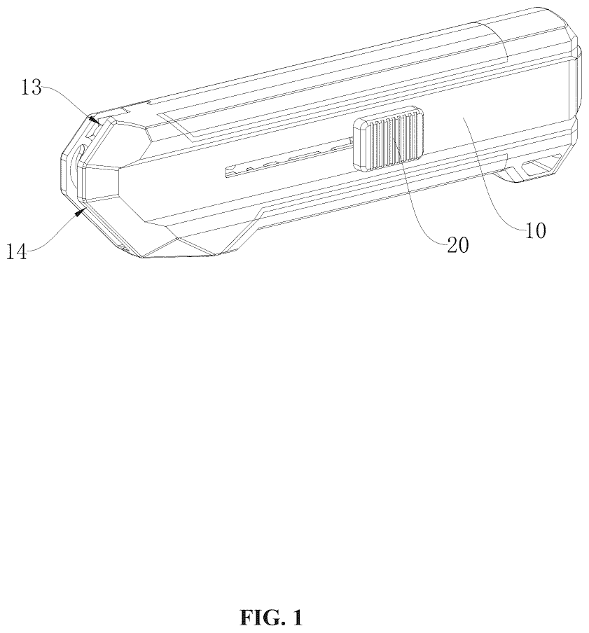

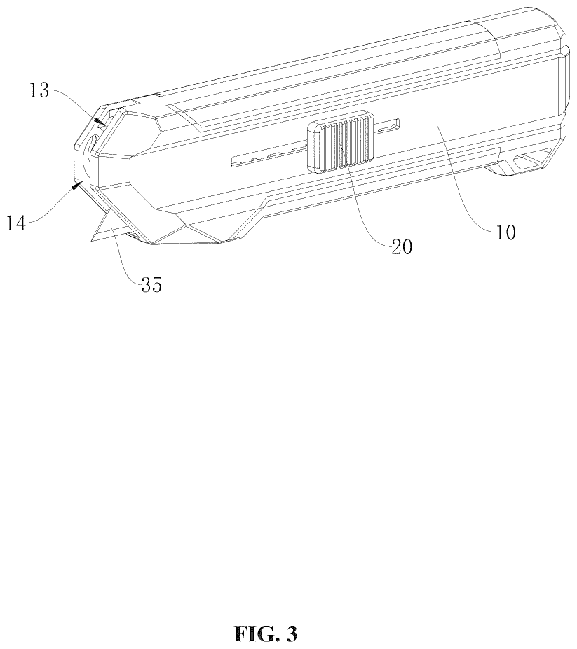

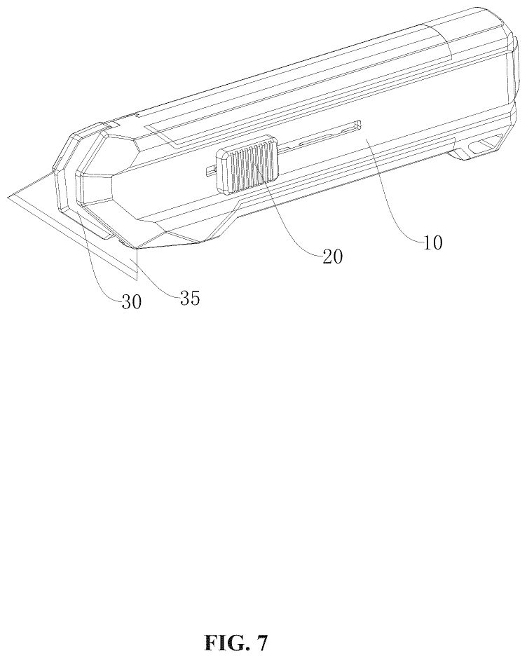

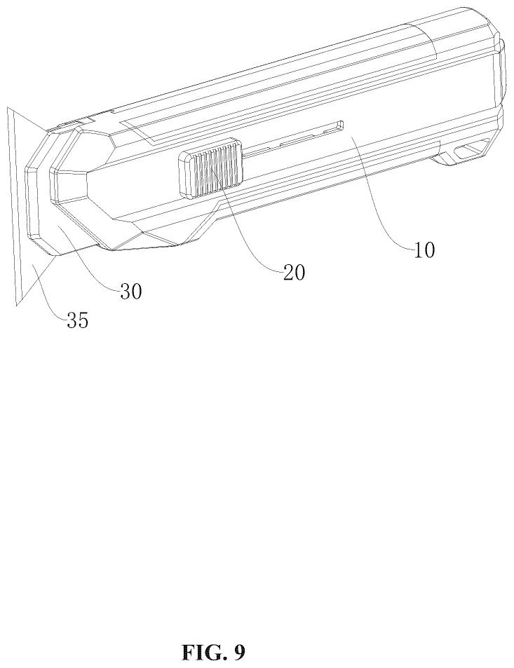

A multi-functional knife is provided. As shown in FIG. 1 to FIG. 11, the multi-functional knife includes a housing 10, a blade holder 30, a first guide assembly, and a second guide assembly. The housing 10 is provided with an accommodating cavity 13 and an opening 14. The opening 14 is provided at a front end of the housing 10 to communicate the accommodating cavity 13 with outside. The blade holder 30 is configured to carry a blade 35. The blade holder 30 is rotatably mounted in the accommodating cavity 13 and is configured to extend out of the accommodating cavity 13 or retract into the accommodating cavity 13 through the opening 14. The first guide assembly includes a first guide rail 222 and a drive member 23, and the drive member 23 is drivably connected to a front side of the blade holder 30 to cause the blade holder 30 to move along the first guide rail 222. In other words, the drive member 23 is pivotally connected to the front side of the blade holder 30, and the drive member 23 moves along the first guide rail 222, and drives the blade holder 30 to move along the first guide rail 222. The second guide assembly includes a fixed surface 122 and a second guide rail 121 provided on the fixed surface 122. A rear side of the blade holder 30 is pivotally connected to the second guide rail 121 to cause the blade holder 30 to move along the second guide rail 121. It can be understood that the blade holder 30 is connected to both the drive member 23 and the second guide rail 121 and can move along the first guide rail 222 and the second guide rail 121, and under the joint guidance of the first guide rail 222 and the second guide rail 121, the blade holder 30 can translate and/or rotate. When the drive member 23 is longitudinally moved along an axial direction relative to the fixed surface 122, the blade holder 30 is selectively rotated into or out of the accommodating cavity 13, so that an orientation of the blade holder 30 is changed to a plurality of positioning angles between a longitudinal position and a transverse position alternately. In other words, through the driving of the blade holder 30 by the drive member 23, the blade holder 30 can translate and/or rotate under guidance of the first guide rail 222 and the second guide rail 121, so that the knife can be quickly positioned at multiple angles to serve as a cutter knife or a scraper knife. The knife is convenient to operate, can improve the working efficiency, and has a compact structure.

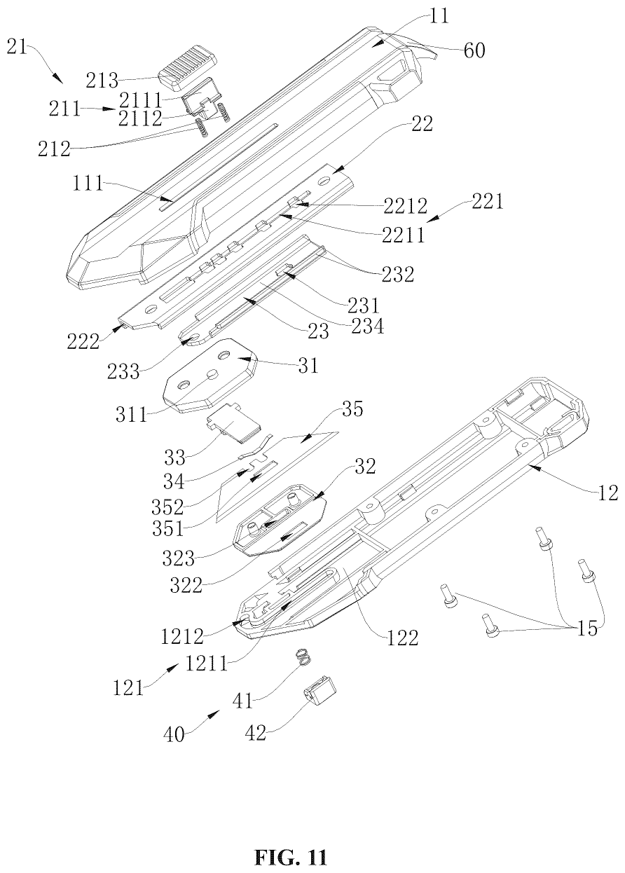

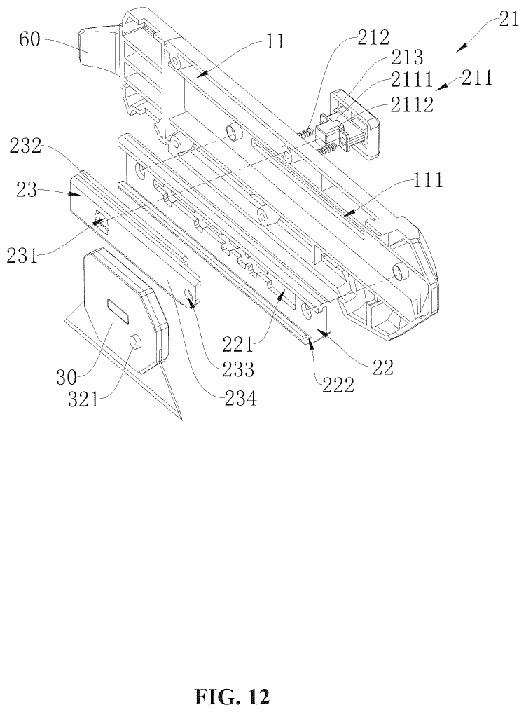

In some embodiments, as shown in FIG. 11 and FIG. 12, the blade holder 30 includes a first guide member 311 and a second guide member 321. The first guide member 311 and the second guide member 321 are respectively arranged on the front side and the rear side of the blade holder 30 in a staggered manner. The first guide member 311 protrudes from the front side of the blade holder 30 and is pivotally connected to the drive member 23 to drive the blade holder 30 to translate and/or rotate along the first guide rail 222. The second guide member 321 protrudes from the rear side of the blade holder 30 and is pivotally connected to the second guide rail 121 to drive the blade holder 30 to translate and/or rotate along the second guide rail 121, so that a longitudinal driving force applied by the drive member 23 to the first guide member 311 is converted to a force for turning the blade holder 30 to the plurality of positioning angles. In other words, the first guide member 311 is connected to the drive member 23, and further, the first guide member 311 is moved in cooperation with the first guide rail 222 and the second guide member 321 is moved in cooperation with the second guide rail 121 to generate deflection and guidance, to generate a thrust force to push the blade holder 30 in a rotational direction, to cause the blade holder 30 to rotate to a preset position, so that the blade 35 can be used longitudinally, transversely, or obliquely for different purposes, thereby expanding the application range of the knife.

Specifically, as shown in FIG. 1 to FIG. 10, projections of the first guide member 311 and the second guide member 321 on the fixed surface 122 do not overlap. When the first guide member 311 moves along the first guide rail 222 and the second guide member 321 moves along the second guide rail 121, a distance between the projections of the first guide member 311 and the second guide member 321 on the fixed surface 122 remains unchanged. Further, the blade holder 30 can smoothly translate and/or rotate under guidance of the first guide rail 222 and the second guide rail 121, so that the knife can be positioned at multiple angles to realize multiple functions of the knife. The knife is easy to store and carry.

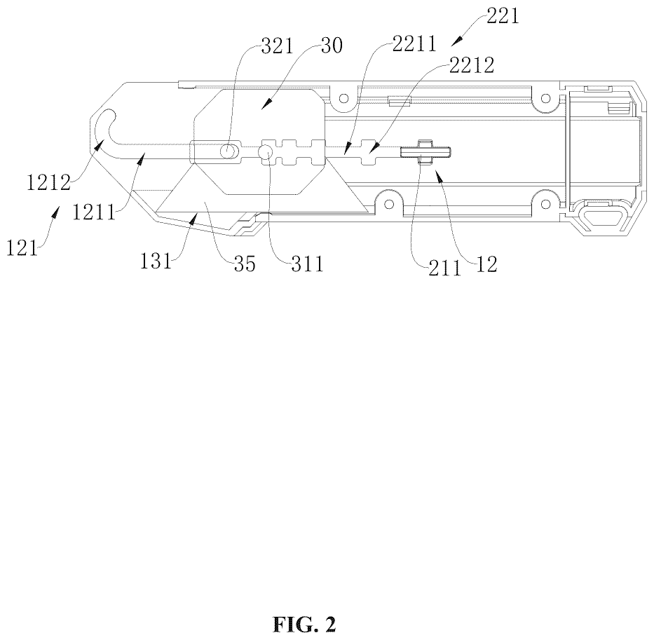

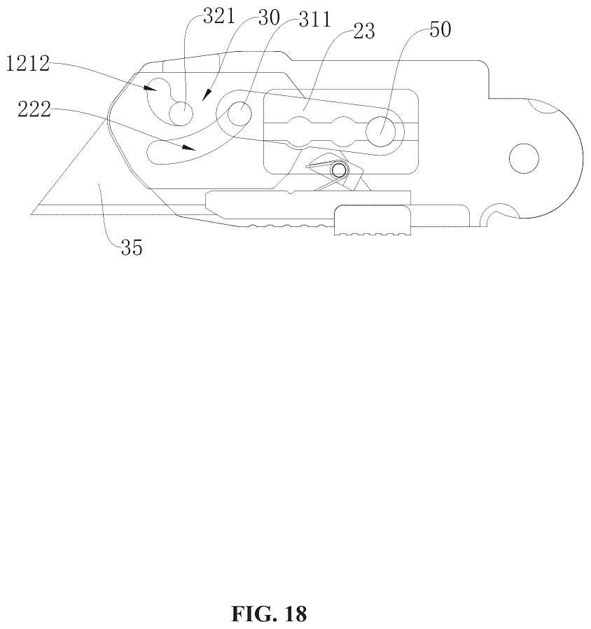

In some embodiments, as shown in FIG. 11 and FIG. 12, the drive member 23 is provided with a driving surface 234, the driving surface 234 is equipped with or directly serves as a sliding member 50, and the first guide member 311 is pivotally connected to a front end of the driving surface 234. Specifically, in an optional embodiment, as shown in FIG. 2, when the driving surface 234 directly serves as the sliding member 50, the first guide member 311 on the blade holder 30 is pivotally connected to the front end of the driving surface 234. When moving along the first guide rail 222, the driving surface 234 can drive the first guide member 311 to move along the first guide rail 222, and at the same time, the second guide member 321 moves along the second guide rail 121, to further cause the blade holder 30 to smoothly translate and/or rotate, so that the knife can be positioned at multiple angles. In an optional embodiment, as shown in FIG. 18, when the driving surface 234 is equipped with the sliding member 50, the first guide member 311 on the blade holder 30 is pivotally connected to the front end of the driving surface 234, and the rear end of the driving surface 234 is pivotally connected to the sliding member 50. When longitudinally moving along the axial direction, the sliding member 50 can push the driving surface 234 to translate and/or rotate, and further drive the first guide member 311 to move along the first guide rail 222, and at the same time, the second guide member 321 moves along the second guide rail 121, to cause the blade holder 30 to smoothly translate and/or rotate, so that the knife can be positioned at multiple angles. It can be understood that the first guide member 311 may be connected to the drive member 23, and the drive member 23 moves along the first guide rail 222, so that the first guide member 311 indirectly moves along the first guide rail 222; or the first guide member 311 may be directly engaged with the first guide rail 222, and driven by the drive member 23 to move along the first guide rail 222.

In some embodiments, as shown in FIG. 1 to FIG. 10, the first guide rail 222 and the second guide rail 121 are each of a linear structure and/or an arc-shaped structure, an extending direction of the first guide rail 222 is at least partially different from an extending direction of the second guide rail 121, the second guide rail 121 includes a main branch 1212, the main branch 1212 extends outward in a direction deviating from the first guide rail 222 so that the blade holder 30 is connected to the fixed surface 122 and the driving surface 234 in at least two partially different directions, and when the blade holder 30 is gradually turned under acting forces from the fixed surface 122 and the driving surface 234, the blade holder 30 is gradually rotated out of or back into the accommodating cavity 13 through the opening 14. In other words, when the first guide member 311 moves along the first guide rail 222 and the second guide member 321 moves along the main branch 1212 of the second guide rail 121, the distance between the projections of the first guide member 311 and the second guide member 321 on the fixed surface 122 remains unchanged, and an extending direction of the main branch 1212 deviates from the extending direction of the first guide rail 222, so that the blade holder 30 is turned under the acting forces from the fixed surface 122 and the driving surface 234. For example, the blade holder 30 is rotated out of the accommodating cavity 13 through the opening 14, so that a blade edge is perpendicular to the axis, and the knife serves as a scraper knife; or the blade holder 30 is rotated back into the accommodating cavity 13 through the opening 14, so that the blade edge is parallel to the axis, and the knife serves as a cutter knife; or the blade holder 30 is rotated so that the blade edge forms other angles with the axis. As such, the knife can be positioned at multiple angles to realize multiple functions.

Specifically, as shown in FIG. 1 to FIG. 10, the second guide rail 121 includes a straight segment 1211, the main branch 1212 and the straight segment 1211 are in integral communication with each other, the main branch 1212 extends outward in an arc-shaped or bent configuration along a direction deviating from the straight segment 1211, and an extending direction of the straight segment 1211 is identical to the extending direction of the first guide rail 222. When the blade holder 30 moves linearly along the straight segment 1211 of the second guide rail 121 and the first guide rail 222, the blade 35 on the blade holder 30 is in a state of retracting into the accommodating cavity 13 or in a state of extending out of the opening 14. When the blade holder 30 turns and moves along the main branch 1212 of the second guide rail 121 and the first guide rail 222, an orientation of the blade 35 on the blade holder 30 is changed to the plurality of positioning angles between the longitudinal position and the transverse position alternately. The blade edge of the blade 35 in the longitudinal position is parallel to the axial direction. The blade edge of the blade 35 in the transverse position is perpendicular to the axial direction.

In other words, when the first guide member 311 on the blade holder 30 moves along the first guide rail 222 and the second guide member 321 is located at the straight segment 1211 of the second guide rail 121, the blade edge is parallel to the axial direction, and the blade holder 30 longitudinally translates along the axial direction, so that the blade edge extends out of or retracts into the accommodating cavity 13 through the opening 14; when the first guide member 311 on the blade holder 30 moves along the first guide rail 222 and the second guide member 321 is located at the main branch 1212 of the second guide rail 121, the blade holder 30 can move and turn to change an angle between the blade edge and the axis, so that the knife can be positioned at multiple angles to meet various usage requirements.

In another optional embodiment, as shown in FIG. 18, the first guide rail 222 extends in an arc-shaped configuration, and the main branch 1212 of the second guide rail 121 extends in an arc-shaped configuration in a direction deviating from the first guide rail 222. When the blade holder 30 moves along the first guide rail 222 and the main branch 1212 of the second guide rail 121, the orientation of the blade 35 on the blade holder 30 can be changed to the plurality of positioning angles between the longitudinal position and the transverse position.

In some embodiments, as shown in FIG. 11, the housing 10 includes an upper housing 11 and a lower housing 12. The upper housing 11 and the lower housing 12 are mounted and fixed by a fastener 15. The drive member 23 is located in the accommodating cavity 13 between the upper housing 11 and the lower housing 12 and is arranged between the upper housing 11 and the blade holder 30. The upper housing 11 is provided with a push button groove 111 which is elongated and extends along the axial direction. The fixed surface 122 is located on an inner surface of the lower housing 12. The second guide rail 121 is formed on the inner surface of the lower housing 12 and is pivotally connected to the second guide member 321 on the blade holder 30.

In some embodiments, as shown in FIG. 11 and FIG. 12, the multi-functional knife further includes a movement assembly 20. The movement assembly 20 includes a push button assembly 21 and a positioning member 22. The positioning member 22 is arranged between the push button assembly 21 and the drive member 23. The positioning member 22 includes the first guide rail 222 and a positioning slot 221. The first guide rail 222 is formed on a rear side of the positioning member 22, and is connected to the drive member 23 to further drive, through the drive member 23, the first guide member 311 to move along the first guide rail 222. The positioning slot 221 is formed on a surface of the positioning member 22. The positioning slot 221 is in communication with outside through the push button groove 111 on the upper housing 11. A lower end of the push button assembly 21 passes through the push button groove 111 and the positioning slot 221 and is connected to the drive member 23 to push the drive member 23 to move axially along the first guide rail 222. The push button assembly 21 is configured to be elastically locked in the positioning slot 221 to lock the blade 35 on the blade holder 30 in the longitudinal position, the transverse position, or a transitional position between the longitudinal position and the transverse position.

In other words, the positioning member 22 is fixedly arranged on the upper housing 11, and the rear side of the positioning member 22 is provided with the first guide rail 222 to engage with engaging portions 232 protruding from two sides of the drive member 23, to allow the drive member 23 to move along the first guide rail 222. Further, the first guide member 311 on the blade holder 30 is pivotally connected to a first connecting hole 233 at a front end of the drive member 23, to allow the first guide member 311 to move along the first guide rail 222. The inner surface of the lower housing 12 is provided with the second guide rail 121 to be connected to the second guide member 321 on the blade holder. The lower end of the push button assembly 21 passes through the push button groove 111 on the upper housing 11 and the positioning slot 221 on the positioning member 22, and is connected to a rear end of the drive member 23. The push button assembly can push the drive member 23 to move and further cause the blade holder 30 to translate and/or rotate. Further, the push button assembly 21 is configured to be elastically locked in the positioning slot 221 to lock the blade holder 30 in a target position, so that the blade 35 is located in the longitudinal position, the transverse position, or other target positions between the longitudinal position and the transverse position, for example, form an angle of 30°, 45°, or 60° with the axis. The movement trajectory of the blade holder 30 is jointly defined by the first guide rail 222 on the rear side of the positioning member 22 and the second guide rail 121 on the surface of the housing 10, so that the blade 35 can be smoothly adjusted to a plurality of positioning positions without requiring the use of an additional complicated accessory, thereby reducing the production costs. In an optional embodiment, the positioning member 22 and the upper housing 11 are integrally formed.

In some embodiments, as shown in FIG. 11 and FIG. 12, the push button assembly 21 includes a push button support 211 and a push button spring 212. The push button support 211 passes through the push button groove 111 and the positioning slot 221 and is connected to the drive member 23. A first end of the push button spring 212 presses against the push button support 211, and a second end of the push button spring 212 presses against the drive member 23, so that the push button support 211 is movably locked in the positioning slot 221. A push button panel 213 is fixedly connected to an end of the push button support 211 extending out of an outer side of the upper housing 11 of the housing, to push the push button support 211 to cause the drive member 23 to move along the first guide rail 222.

Further, the push button support 211 includes a first connecting segment 2111 and a second connecting segment 2112 distributed perpendicularly to the driving surface 234. The positioning slot 221 includes a movement region 2211 and a plurality of positioning regions 2212, and the movement region 2211 is elongated and extends along the axial direction, and the plurality of positioning regions 2212 are distributed at intervals. The first connecting segment 2111 passes through the push button groove 111 on the upper housing 11 and is configured to move along the movement region 2211 of the positioning slot 221. The second connecting segment 2112 is connected to a second connecting hole 231 on the drive member 23, and is configured to engage with a positioning region 2212 of the positioning regions 2212 to lock the drive member 23, so that the blade holder 30 is retained in the corresponding target position. In other words, the first connecting segment 2111 of the push button support 211 is configured to move along the push button groove 111 on the upper housing 11, and the first connecting segment 2111 is also configured to move along the positioning slot 221 on the positioning member 22. The second connecting segment 2112 of the push button support 211 is configured to engage with a positioning region 2212 of the positioning regions 2212 of the positioning slot 221 to position the blade holder 30 and thus position the blade 35.

Specifically, the push button assembly 21 is pressed and pushed to compress the push button spring 212, so that the push button support 211 moves inward, the second connecting segment 2112 of the push button support 211 is separated from the positioning region 2212 of the positioning slot 221 of the positioning member 22, and the first connecting segment 2111 is engaged with the movement region 2211. As such, the push button assembly 21 can drive the drive member 23 to move. Then, the push button assembly 21 is released. The push button spring 212 causes the push button support 211 to move outward, and the second connecting segment 2112 of the push button support 211 is engaged with a positioning region 2212 of the positioning regions 2212 to lock the drive member 23 and thus position the blade holder 30. The position of the blade holder 30 can be changed and locked by one-handed operation, thereby improving the convenience and safety of operation. In addition, with the arrangement of the first guide rail 222 and the second guide rail 121, the blade holder 30 can be smoothly moved and turned, and the push button assembly 21 can be pressed and pushed more easily and smoothly.

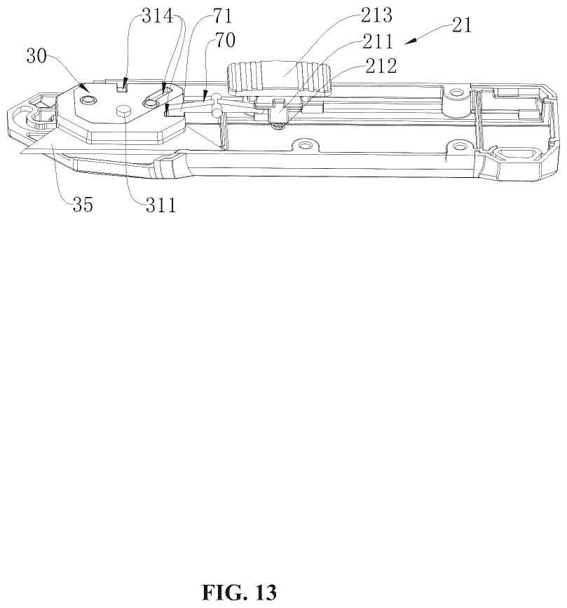

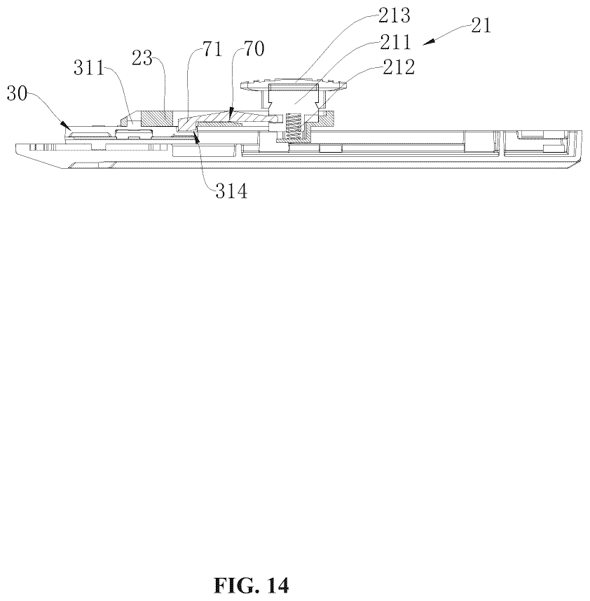

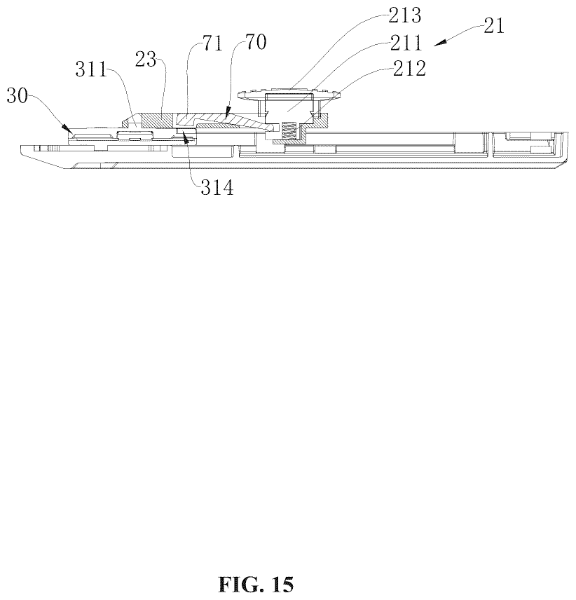

Further, as shown in FIG. 13 to FIG. 15, the multi-functional knife further includes an anti-rotation member 70. The anti-rotation member 70 is rotatably connected to the drive member 23 and can longitudinally move along the axial direction together with the drive member 23. A first end of the anti-rotation member 70 is movably connected to the push button assembly 21. When the push button assembly 21 moves toward an inner or outer side of the housing 10 in a direction perpendicular to the fixed surface 122, the anti-rotation member 70 is driven to rotate relative to the drive member 23. A stop portion 71 is arranged on and protrudes from a side of a second end of the anti-rotation member 70 facing the blade holder 30. A plurality of stopping grooves 314 configured to accommodate the stop portion 71 are provided on the front side of the blade holder 30. When the anti-rotation member 70 is rotated under the action of the push button assembly 21, the stop portion 71 can be engaged with or disengaged from a stopping groove 314 of the stopping grooves 314. It can be understood that when the push button assembly 21 is pressed, the push button assembly 21 moves toward the inner side of the housing 10 to drive the anti-rotation member 70 to rotate, so that the stop portion 71 is separated from the stopping groove 314, and the blade holder 30 can rotate relative to the drive member 23. When the push button assembly 21 is released, the push button assembly 21 moves toward the outer side of the housing 10 to drive the anti-rotation member 70 to rotate, so that the stop portion 71 is engaged with the stopping groove 314, and the blade holder 30 is locked with the drive member 23. In this way, the blade holder 30 is retained in the longitudinal position, the transverse position, or other target positions between the longitudinal position and the transverse position. In other words, through the joint effect of the engagement of the push button assembly 21 with the positioning slot 221 and the engagement of the anti-rotation member 70 with the blade holder 30, the position of the blade holder 30 can be locked, thereby improving the reliability and safety of the multi-functional knife during use. In another optional embodiment, an anti-rotation spring is arranged below a side of the anti-rotation member 70 close to the push button assembly 21 to provide a torque for the anti-rotation member 70, so that the stop portion 71 on the other side of the anti-rotation member 70 moves downward to engage with the stopping groove 314.

In some embodiments, as shown in FIG. 1 to FIG. 10, the straight segment 1211 of the second guide rail 121 overlaps with the first guide rail 222 in a direction perpendicular to the axial direction, and the main branch 1212 extends radially outward in an arc-shaped configuration from a front end of the straight segment 1211. When the drive member 23 moves along the first guide rail 222, the blade holder 30 can be moved to a retracted position, a first longitudinal position, a second longitudinal position, a transitional position, and the transverse position along the second guide rail 121. When the second guide member 321 is located at a starting end of the straight segment 1211 of the second guide rail 121, the blade holder 30 is longitudinally in the retracted position, and the blade 35 is retracted into the accommodating cavity 13. When the second guide member 321 moves forward along the straight segment 1211 of the second guide rail 121, the blade holder 30 is sequentially in the first longitudinal position where the blade 35 partially extends out of the opening 14 and the second longitudinal position where the blade 35 completely extends out of the opening 14. When the second guide member 321 moves from the straight segment 1211 to the main branch 1212, the blade holder 30 is turned to the transitional position, and the blade 35 is rotated out of the accommodating cavity 13 by a turning angle of substantially 0° to 90° or 90° to 180°, so that the blade 35 enters an oblique state to serve as an oblique scraper knife. When the second guide member 321 moves to an end of the main branch 1212, the blade holder 30 is rotated to the transverse position, and the blade 35 enters a transverse state to serve as a transverse scraper knife.

Specifically, as shown in FIG. 2, the blade holder 30 is longitudinally in the retracted position, and the second connecting segment 2112 of the push button support 211 is located in the rightmost positioning region 2212 of the positioning member 22. In this case, the drive member 23 is located on the rightmost side, the first guide member 311 of the blade holder 30 is connected to the first connecting hole 233 at the front end of the drive member 23, the second guide member 321 of the blade holder 30 is located in a right part of the straight segment 1211 of the second guide rail 121, and the blade 35 is completely accommodated in the accommodating cavity 13.

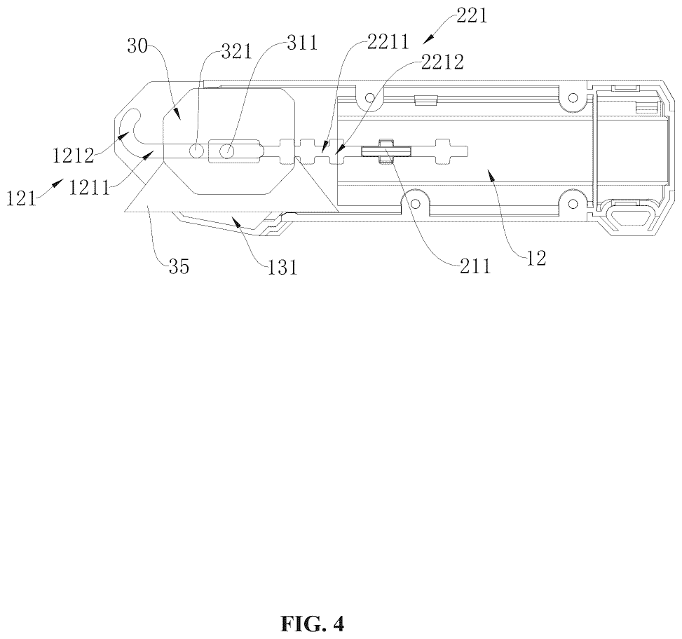

As shown in FIG. 4, the push button assembly 21 is pressed, so that the second connecting segment 2112 of the push button support 211 is separated from the positioning region 2212 of the positioning slot 221 of the positioning member 22, and the first connecting segment 2111 is engaged with the movement region 2211. As such, the push button assembly 21 can drive the drive member 23 to move forward along the first guide rail 222. The first guide member 311 of the blade holder 30 is connected to the first connecting hole 233 and also moves forward along the first guide rail 222, and the second guide member 321 of the blade holder 30 moves forward along the axial direction to a middle part of the straight segment 1211 of the second guide rail 121, so that the blade holder 30 moves forward along the axial direction to the first longitudinal position. Then, the push button assembly 21 is released. The push button spring 212 causes the push button support 211 to move outward, the second connecting segment 2112 of the push button support 211 is engaged with the positioning region 2212 which is the second from the right, so that the blade holder 30 is locked in the first longitudinal position, and a part of a triangular tip of an end of the blade 35 is exposed out of the housing 10 for use as a cutter knife.

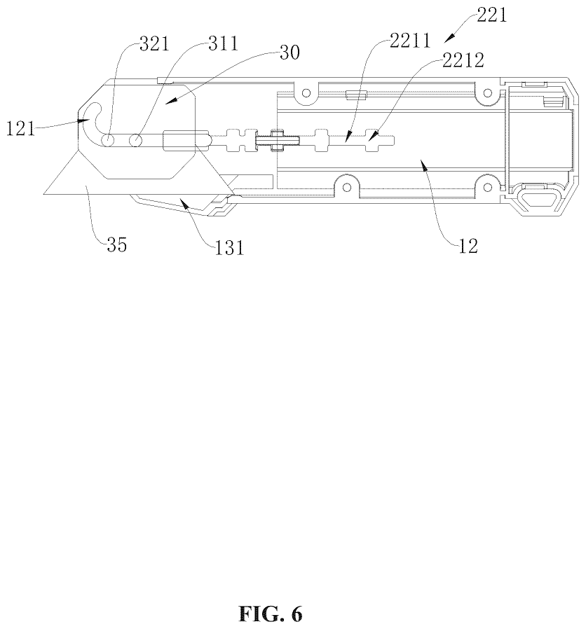

As shown in FIG. 6, the push button assembly 21 is pressed, so that the second connecting segment 2112 of the push button support 211 is separated from the positioning region 2212 of the positioning slot 221 of the positioning member 22, and the first connecting segment 2111 is engaged with the movement region 2211. As such, the push button assembly 21 can drive the drive member 23 to move forward along the first guide rail 222. The first guide member 311 of the blade holder 30 is hingedly connected to the first connecting hole 233 and also moves forward along the first guide rail 222, and the second guide member 321 of the blade holder 30 moves forward along the axial direction to a left part of the straight segment 1211 of the second guide rail 121, so that the blade holder 30 moves forward along the axial direction to the second longitudinal position. Then, the push button assembly 21 is released, the push button spring 212 causes the push button support 211 to move outward, the second connecting segment 2112 of the push button support 211 is engaged with the positioning region 2212 which is the third from the right, so that the blade holder 30 is locked in the second longitudinal position, and the triangular tip of the end of the blade 35 is exposed out of the housing 10, for use as a cutter knife.

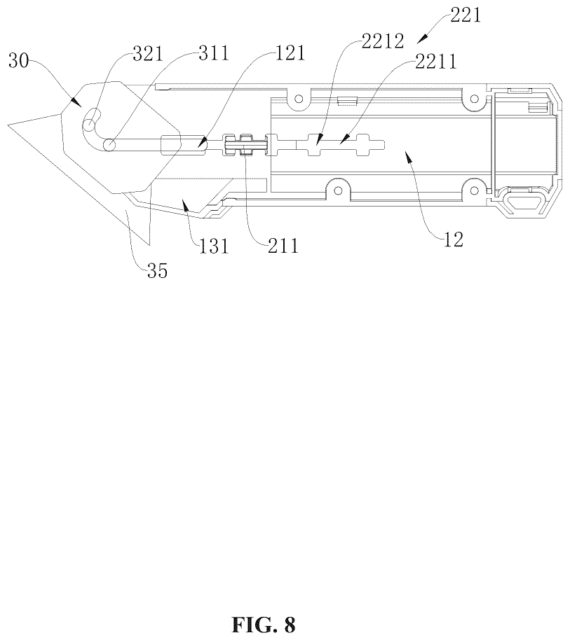

As shown in FIG. 8, the push button assembly 21 is pressed, so that the second connecting segment 2112 of the push button support 211 is separated from the positioning region 2212 of the positioning slot 221 of the positioning member 22, and the first connecting segment 2111 is engaged with the movement region 2211. As such, the push button assembly 21 can drive the drive member 23 to move forward along the first guide rail 222. The first guide member 311 of the blade holder 30 is hingedly connected to the first connecting hole 233 and also moves forward along the first guide rail 222, and the second guide member 321 of the blade holder 30 moves to a middle part of the main branch 1212 of the second guide rail 121, so that the blade holder 30 rotates counterclockwise to the transitional position while moving forward along the axial direction. Then, the push button assembly 21 is released, the push button spring 212 causes the push button support 211 to move outward, the second connecting segment 2112 of the push button support 211 is engaged with the positioning region 2212 which is the second from the left, so that the blade holder 30 is locked in the transitional position, and the blade edge of the blade 35 is completely exposed out of the housing 10 and forms an angle of 45° with the housing 10, for use as an oblique scraper knife. Further, the housing 10 is provided with an avoidance area 131. The avoidance area 131 is located at one side or two sides of the front end of the housing 10, the accommodating cavity 13 is in lateral communication with the outside through the avoidance area 131, and when the blade holder 30 rotates, the avoidance area 131 allows the blade holder 30 to rotate out of or into the accommodating cavity 13, to avoid interference between the blade 35 and the housing 10.

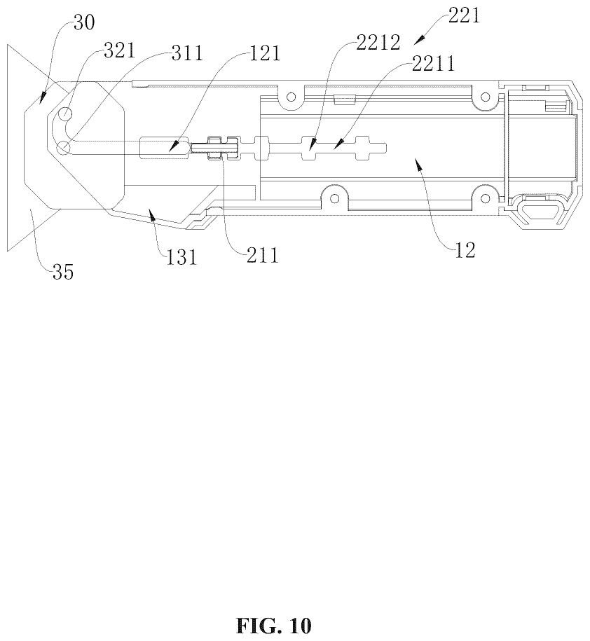

As shown in FIG. 10, the push button assembly 21 is pressed, so that the second connecting segment 2112 of the push button support 211 is separated from the positioning region 2212 of the positioning slot 221 of the positioning member 22, and the first connecting segment 2111 is engaged with the movement region 2211. As such, the push button assembly 21 can drive the drive member 23 to move forward along the first guide rail 222. The first guide member 311 of the blade holder 30 is hingedly connected to the first connecting hole 233 and also moves forward along the first guide rail 222, and the second guide member 321 of the blade holder 30 moves to an end part of the main branch 1212 of the second guide rail 121, so that the blade holder 30 rotates counterclockwise to the transverse position while moving forward along the axial direction. Then, the push button assembly 21 is released, the push button spring 212 causes the push button support 211 to move outward, the second connecting segment 2112 of the push button support 211 is engaged with the leftmost positioning region 2212, so that the blade holder 30 is locked in the transverse position, and the blade edge of the blade 35 is completely exposed out of the housing 10 and forms an angle of 90° with the housing 10, for use as a transverse scraper knife. It can be understood that by further extending the second guide rail 121, the blade holder 30 can continue to translate and/or rotate, so that the blade edge of the blade 35 forms an angle of 135°, or even 180°, or any other angle in the range of 90° to 180° with the housing 10.

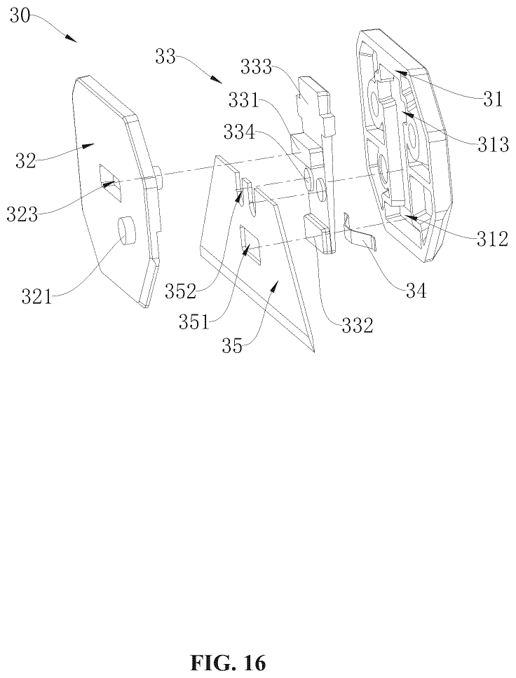

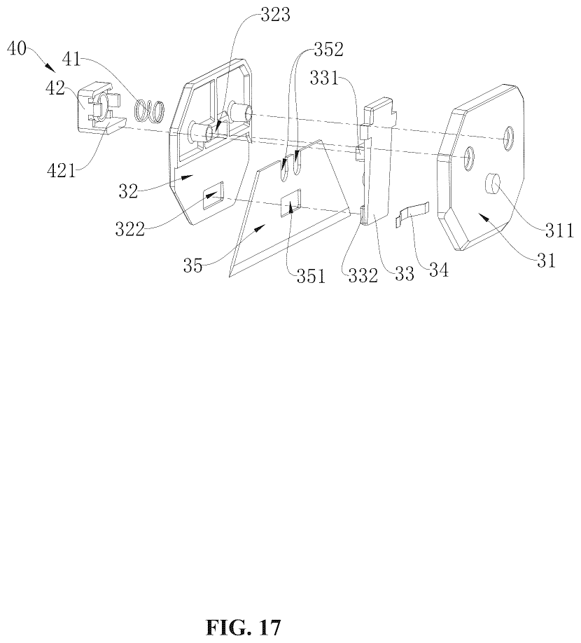

In some embodiments, as shown in FIG. 16 and FIG. 17, the blade holder 30 includes a first frame 31, a middle frame 33, and a second frame 32. The middle frame 33 is elastically connected to the first frame 31 and the second frame 32. The first guide member 311 protrudes radially outward from the first frame 31, is pivotally connected to the first connecting hole 233 at the front end of the drive member 23, and is driven by the drive member 23 to move along the first guide rail 222. The second guide member 321 protrudes radially outward from the second frame 32 and is disposed eccentrically relative to the first guide member 311 and is connected to the second guide rail 121 of the lower housing 12. The blade 35 is detachably mounted between the second guide member 321 and the middle frame 33.

In some embodiments, as shown in FIG. 16 and FIG. 17, the blade holder 30 further includes an elastic piece 34, an elastic piece groove 312 for mounting the elastic piece 34 and a first mounting groove 313 for accommodating the middle frame 33 are provided on a side of the first frame 31 facing the second frame 32, and the elastic piece 34 is mounted between the first frame 31 and the middle frame 33 to provide an acting force for pressing the middle frame 33 against the second frame 32, so that the blade 35 is clamped between the middle frame 33 and the second frame 32.

Further, the blade 35 includes a limiting notch 352 and a mounting hole 351 extending through the blade 35, a main body 333 of the middle frame 33 is accommodated in the first mounting groove 313, a limiting portion 334 and a fixing portion 332 are arranged on and protrude from a side of the main body 333 facing the second frame 32, the limiting portion 334 is configured to engage with the limiting notch 352, the fixing portion 332 is configured to pass through the mounting hole 351 to fix the blade 35, a second mounting groove 322 is provided on a side of the second frame 32 facing the middle frame 33, and the second mounting groove 322 is configured to accommodate an end of the fixing portion 332.

In some embodiments, as shown in FIG. 11, the multi-functional knife further includes a blade change assembly 40 for changing the blade 35. The blade change assembly 40 includes a blade change button 42 and a return spring 41. The return spring 41 is configured so that the blade change button 42 is pressably arranged on the lower housing 12 of the housing. A protruding portion 421 is arranged on and protrudes from a side of the blade change button 42 facing the blade holder 30. The second frame 32 further includes a blade change hole 323 extending through the second frame 32. An extension portion 331 is arranged on and protrudes from the side of the main body 333 of the middle frame 33 facing the second frame 32. The extension portion 331 extends into the blade change hole 323. When the blade holder 30 is located in the second longitudinal position, the protruding portion is aligned with the blade change hole 323 to press against the extension portion 331, and the blade change button 42 is pressed to cause the middle frame 33 to move toward the first frame 31, to separate the fixing portion 332 from the mounting hole 351 for replacing the blade 35.

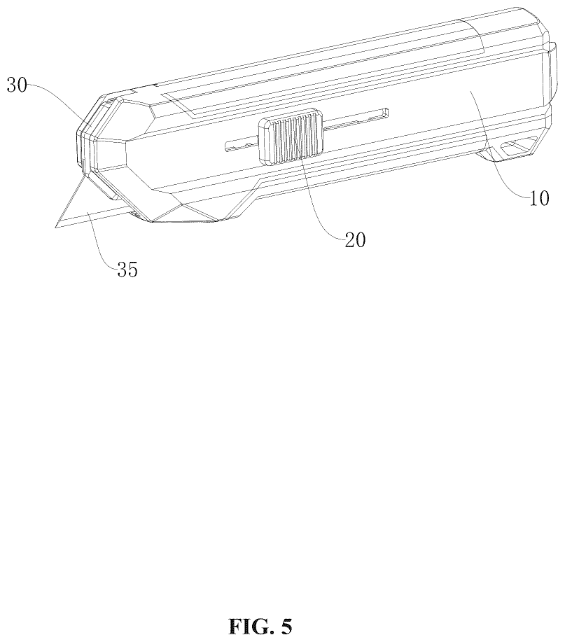

Specifically, when the blade holder 30 moves to the position shown in FIG. 5 and FIG. 6, i.e., is in the second longitudinal position, the blade change hole 323 on the second frame 32 is exactly aligned with the protruding portion 421 of the blade change button 42. When the blade change button 42 is pressed, the protruding portion 421 passes through the blade change hole 323 and urges against the extension portion 331 of the middle frame 33 to push the middle frame 33 toward the first mounting groove 313 of the first frame 31, so that the fixing portion 332 of the middle frame 33 is detached from the second mounting groove 322 of the second frame 32, and further the fixing portion 332 is separated from the mounting hole 351 of the blade 35. As such, the blade 35 can be taken out. When the blade change button 42 is released, the return spring 41 pushes the blade change button 42 outward. Under the action of the elastic piece 34, the middle frame 33 urges against the second frame 32, and the fixing portion 332 of the middle frame 33 passes through the mounting hole 351 of the blade 35 and is inserted into the second mounting groove 322 of the second frame 32 to fix the blade 35. In other words, the blade 35 in the blade holder 30 can be quickly and safely replaced through the blade change button 42.

In some embodiments, a tail end of the housing 10 includes a curved hook portion 60 configured to pry an object such as a lid of a paint bucket.

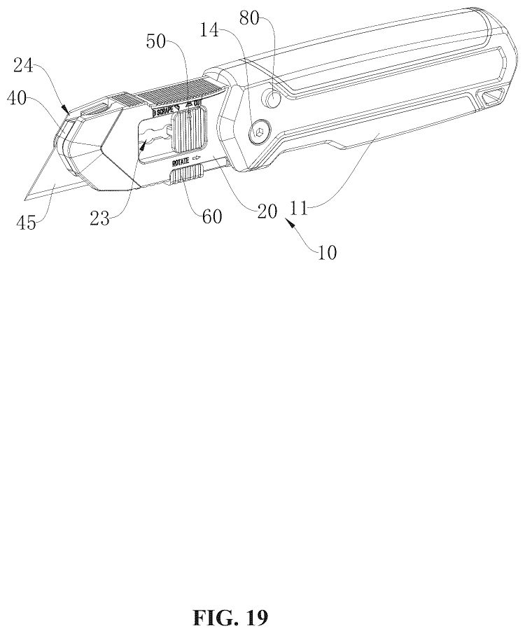

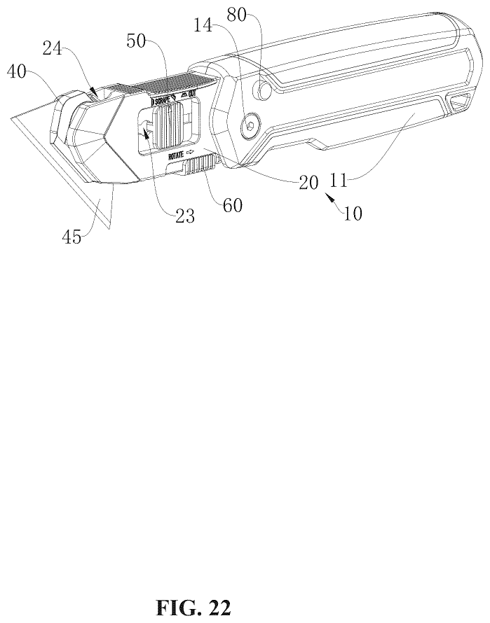

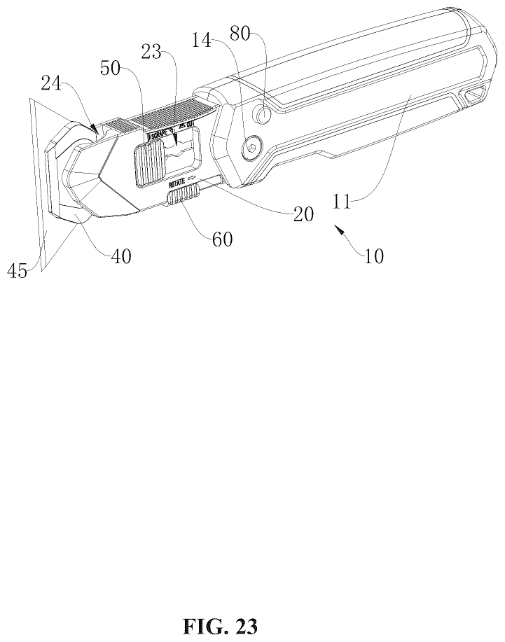

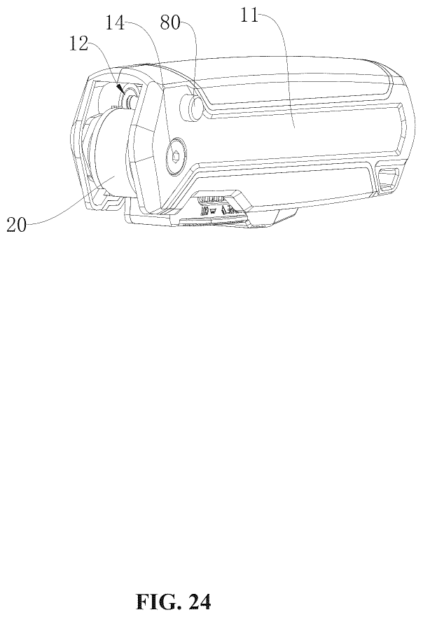

A multi-functional folding knife is provided. As shown in FIG. 19 to FIG. 25, the multi-functional folding knife includes a housing 10, a blade holder 40, a first guide assembly, and a second guide assembly. The housing 10 includes an outer housing 11 and an inner housing 20. The outer housing 11 is provided with a main accommodating chamber 12 and an opening 13. The opening 13 is provided on a side surface of the outer housing 11 to communicate the main accommodating chamber 12 with outside. The inner housing 20 is rotatably and foldably mounted in the main accommodating chamber 12 by a main shaft 14, and can be rotated out of or into the main accommodating chamber 12 through the opening 13. The inner housing 20 is provided with an accommodating cavity 23 and an end opening 24. The end opening 24 is provided at a front end of the inner housing 20 to communicate the accommodating cavity 23 with outside. The blade holder 40 is configured to hold a blade 45. The blade holder 40 is rotatably mounted in the accommodating cavity 23 and is configured to rotate out of or into the accommodating cavity 23 through the end opening 24. The inner housing 20 is further provided with an avoidance area 231. The avoidance area 231 is located at one side or two sides of the front end of the inner housing 20, the accommodating cavity 23 is in lateral communication with the outside through the avoidance area 231, and when the blade holder 40 rotates, the avoidance area 231 allows the blade holder 40 to rotate out of or into the accommodating cavity 23, to avoid interference between the blade 45 and the inner housing 20. Specifically, when the inner housing 20 is rotated out of the main accommodating chamber 12, the knife is in an unfolded state, a blade edge of the blade 45 extends out of the accommodating cavity 23 through the end opening 24, and the blade 45 can be rotated through the blade holder 40 and positioned at multiple angles for use. When the inner housing 20 is rotated into the main accommodating chamber 12, the knife is in a folded state, and the blade 45 and the inner housing 20 are accommodated in the main accommodating chamber 12, to prevent the blade 45 from being exposed to cause accidental injury, and reduce the length of the knife to facilitate carrying.

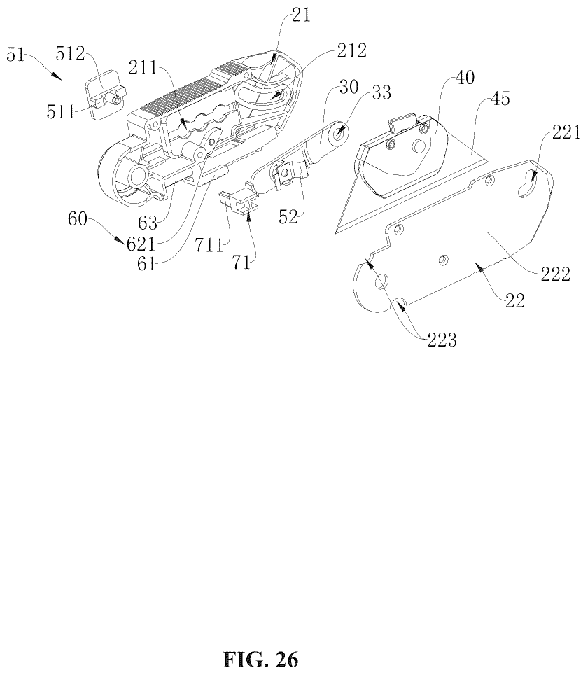

As shown in FIG. 26 to FIG. 28, the first guide assembly includes a first guide rail 212 and a drive member 30, and the drive member 30 is drivably connected to a front side of the blade holder 40 to cause the blade holder 40 to move along the first guide rail 212. In other words, the drive member 30 is pivotally connected to the front side of the blade holder 40. A translation and/or rotation of the drive member 30 can drive the blade holder 40 to move along the first guide rail 212. The second guide assembly includes a fixed surface 222 and a second guide rail 221 provided on the fixed surface 222. A rear side of the blade holder 40 is pivotally connected to the second guide rail 221 to cause the blade holder 40 to move along the second guide rail 221.

It can be understood that the blade holder 40 is connected to both the first guide rail 212 and the second guide rail 221 and can move along the first guide rail 212 and the second guide rail 221, and under the joint guidance of the first guide rail 212 and the second guide rail 221, the blade holder 40 can translate and/or rotate. In other words, when the drive member 30 translates and/or rotates relative to the fixed surface 222, the blade holder 40 is selectively rotated into or out of the accommodating cavity 23, so that an orientation of the blade holder 40 is changed to a plurality of positioning angles between a longitudinal position and a transverse position alternately, enabling the knife to serve as a cutter knife or a scraper knife. The knife is convenient to operate, can improve the working efficiency, and has a compact structure.

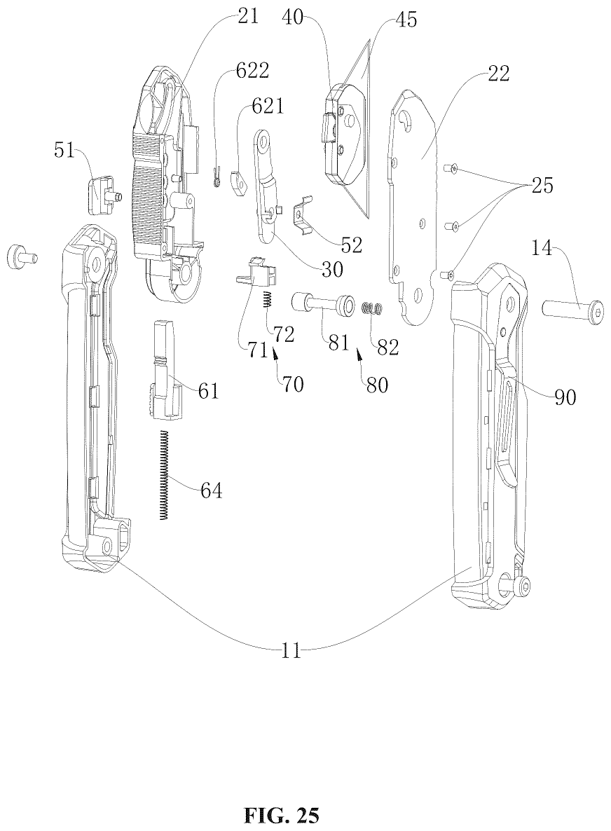

In some embodiments, as shown in FIG. 25 to FIG. 28, the multi-functional folding knife further includes a sliding assembly 50, the drive member 30 is provided with a driving surface 34, and the sliding assembly 50 is mounted on the driving surface 34 to drive the drive member 30 to translate and/or rotate. Specifically, by pushing the sliding assembly 50 to move longitudinally along an axial direction, the drive member 30 can be driven to translate and/or rotate, to further drive the blade holder 40 to translate and/or rotate, so that the blade holder 40 can be rotated out of or into the accommodating cavity 23 and thus turned to multiple angles.

Specifically, as shown in FIG. 25 and FIG. 26, the blade holder 40 includes a first guide member 411 and a second guide member 421. The first guide member 411 and the second guide member 421 are respectively arranged on the front side and the rear side of the blade holder 40 in a staggered manner. The first guide member 411 protrudes from the front side of the blade holder 40 and is pivotally connected to a front end of the driving surface 34 and the first guide rail 212 to drive the blade holder 40 to translate and/or rotate along the first guide rail 212. The second guide member 421 protrudes from the rear side of the blade holder 40 and is pivotally connected to the second guide rail 221 to drive the blade holder 40 to translate and/or rotate along the second guide rail 221, so that a longitudinal driving force applied by the sliding assembly 50 to the drive member 30 is converted to a force for turning the drive member 30 to the blade holder 40 to the plurality of positioning angles.

In other words, the first guide member 411 is pivotally connected to the drive member 30, so that the blade holder 40 is driven by the drive member 30 to move. In addition, the first guide member 411 is pivotally connected to the first guide rail and is moved in engagement with the first guide rail 212 and the second guide member 421 is moved in engagement with the second guide rail 221 to generate deflection and guidance, so as to generate a thrust force to push the blade holder 40 in a rotational direction, to cause the blade holder 40 to rotate to a preset position, so that the blade 45 can be used longitudinally, transversely, or obliquely for different purposes, thereby expanding the application range of the knife.

Specifically, a front end of the drive member 30 is provided with a first connecting hole 33, a rear end of the drive member 30 is provided with a second connecting hole 31, the first guide member 411 on the blade holder 40 is pivotally connected to the first connecting hole 33, and the sliding assembly 50 is pivotally connected to the second connecting hole 31. When being pushed to longitudinally move along the axial direction, the sliding assembly 50 can push the drive member 30 to translate and/or rotate, and further drive the first guide member 411 to move along the first guide rail 212, and at the same time, the second guide member 421 moves along the second guide rail 221, to cause the blade holder 40 to smoothly translate and/or rotate along the accommodating cavity 23, so that the knife can be positioned at multiple angles.

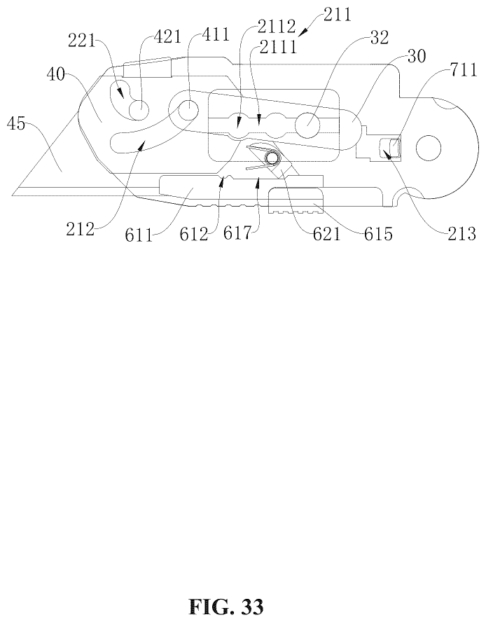

In some embodiments, as shown in FIG. 33 to FIG. 36, the first guide rail 212 and the second guide rail 221 are respectively of arc-shaped structures with different trajectories, the first guide rail 212 extends forward in a direction deviating from the second guide rail 221, and the second guide rail 221 extends outward in a direction deviating from the first guide rail 212, so that the blade holder 40 is gradually turned under acting forces in two different directions and thus gradually rotated out of or back into the accommodating cavity 23 through the end opening 24. As such, an orientation of the blade 45 on the blade holder 40 is changed to the plurality of positioning angles between the longitudinal position and the transverse position.

Specifically, projections of the first guide member 411 and the second guide member 421 on the fixed surface 222 do not overlap, and a distance between the projections of the first guide member 411 and the second guide member 421 on the fixed surface 222 remains unchanged. Therefore, when the extending direction of the first guide rail 212 deviates from the extending direction of the second guide rail 221, the first guide member 411 moves along the first guide rail 212, and the second guide member 421 moves along the second guide rail 221, relative positions of the first guide member 411 and the second guide member 421 on the fixed surface 222 are changed under the guidance of the first guide rail 212 and the second guide rail 221, so that the blade holder 40 can smoothly translate and/or rotate. As such, the knife can be positioned at multiple angles to realize multiple functions. The knife is easy to store and carry.

In some embodiments, as shown in FIG. 25 to FIG. 28, the inner housing 20 further includes an upper housing 21 and a lower housing 22. The upper housing 21 and the lower housing 22 are mounted and fixed by a fastener 25. The drive member 30 is accommodated in the accommodating cavity 23 between the upper housing 21 and the lower housing 22, and is located between the upper housing 21 and the blade holder 40. The upper housing 21 is provided with the first guide rail 212 and a positioning slot 211. The first guide rail 212 is formed on an inner surface of the upper housing 21 and is pivotally connected to the first guide member 411 on the blade holder 40. The positioning slot 211 is formed on a surface of the upper housing 21 and extends along the axial direction. The drive member 30 is configured to be elastically locked in the positioning slot 211 to lock the blade 45 on the blade holder 40 in the longitudinal position, the transverse position, or a transitional position between the longitudinal position and the transverse position. For example, the blade 45 forms an angle of 30°, 45°, or 60° with the axis. The fixed surface 222 is located on a surface of the lower housing 22, and the second guide rail 221 is formed on the surface of the lower housing 22 and is pivotally connected to the second guide member 421 on the blade holder 40. In other words, the blade holder 40 is movably connected to the upper housing 21 and the lower housing 22 by the first guide member 411 and the second guide member 421. The movement trajectory of the blade holder 40 is jointly defined by the first guide rail 212 on the rear side of the upper housing 21 and the second guide rail 221 on the surface of the lower housing 22, so that the blade 45 can be smoothly adjusted to a plurality of positioning positions without requiring the use of an additional complicated accessory, thereby reducing the production costs.

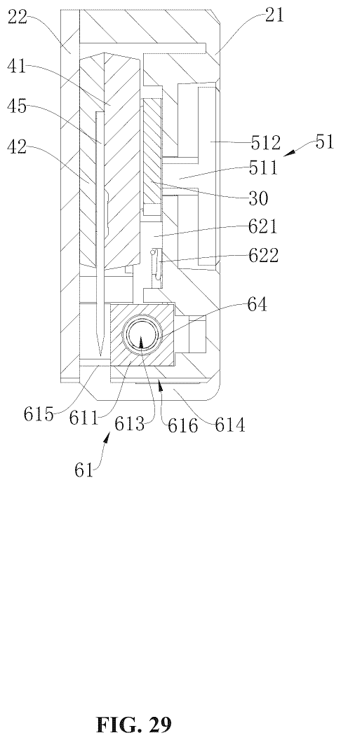

In some embodiments, as shown in FIG. 26 to FIG. 29, a lower end of the sliding assembly 50 passes through the positioning slot 211 and is pivotally connected to the drive member 30, the sliding assembly 50 is configured to move along the positioning slot 211, and further, the sliding assembly 50 is pushed to drive the drive member 30 to cause the blade holder 40 to translate and/or rotate. Specifically, the sliding assembly 50 includes a sliding support 51 and a sliding elastic piece 52. The sliding support 51 passes through the positioning slot 211 and is pivotally connected to the second connecting hole 31 on the drive member 30. The sliding elastic piece 52 is connected to the sliding support 51 and abuts between the drive member 30 and the lower housing 22. The drive member 30 is movably locked in the positioning slot 211 by pressing the sliding support 51. A sliding panel 512 is arranged on an end of the sliding support 51 extending out of an outer side of the upper housing 21, to push the sliding assembly 50 to move along the positioning slot 211.

Further, as shown in FIG. 33 to FIG. 36, the positioning slot 211 includes a movement region 2111 and a plurality of positioning regions 2112, the movement region 2111 is elongated and extends longitudinally along the axial direction, and the plurality of positioning regions 2112 are distributed at intervals. An engaging portion 511 is arranged on a side of the sliding support 51 facing the drive member 30 and is elongated. The engaging portion 511 is configured to move along the movement region 2111 of the positioning slot 211. A positioning portion 32 is arranged on and protrudes from a side of the drive member 30 facing the positioning slot 211. The positioning portion 32 is configured to engage with a positioning region 2112 of the plurality of positioning regions 2112 to lock the drive member 30, so that the blade holder 40 is retained in a target position.

In other words, the engaging portion 511 of the sliding support 51 is configured to move along the movement region 2111 of the positioning slot 211, and the positioning portion 32 of the drive member 30 is configured to detachably engage with a positioning region 2112 of the positioning regions 2112 of the positioning slot 211 to position the blade holder 40 and thus position the blade 45. In an optional embodiment, the positioning portion 32 is arranged concentrically with the second connecting hole 31 to achieve a compact structure and simplify the operation.

Specifically, the sliding support 51 is pressed and pushed to compress the sliding elastic piece 52, so that the sliding support 51 and the drive member 30 move inward, the positioning portion 32 of the drive member 30 is disengaged from the positioning region 2212 of the positioning slot 211 of the upper housing 21, and the engaging portion 511 of the sliding support 51 moves in engagement with the movement region 2111 of the positioning slot 211. As such, the sliding assembly 50 can drive the drive member 30 to translate and/or rotate. Then, the sliding support 51 is released. The sliding elastic piece 52 allows the sliding support 51 and the drive member 30 to move outward, the engaging portion 511 of the sliding support 51 is disengaged from the movement region 2111 of the positioning slot 211, and the positioning portion 32 of the drive member 30 is engaged with one of the positioning regions 2112 to lock the drive member 30 and thus position the blade holder 40. The position of the blade holder 40 can be changed and locked by one-handed operation, thereby improving the convenience and safety of operation. In addition, with the arrangement of the first guide rail 212 and the second guide rail 221, the blade holder 40 can be smoothly moved and turned, and the sliding assembly 50 can be pressed and pushed more easily and smoothly.

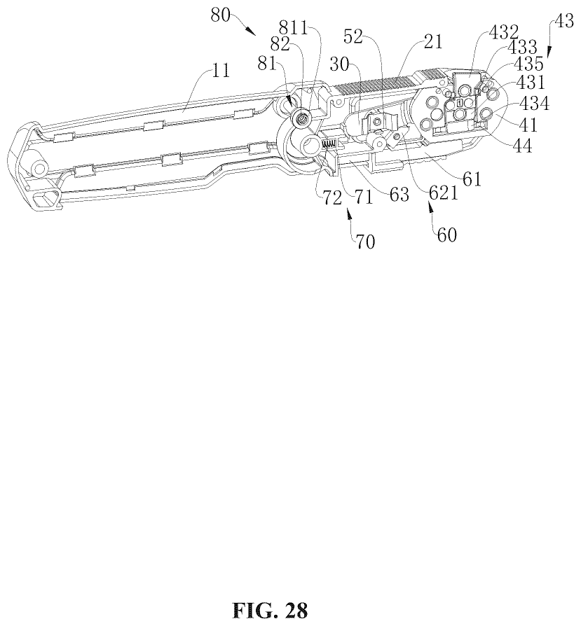

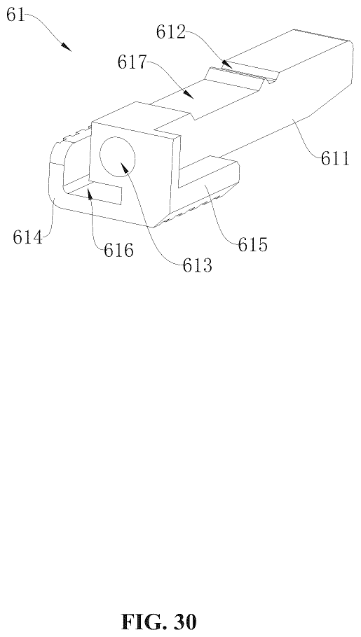

In some embodiments, as shown in FIG. 28 to FIG. 30, the multi-functional folding knife further includes a safety assembly 60. The safety assembly 60 includes a safety push button 61, a safety spring 64, and an engaging member 621. The safety push button 61 is longitudinally movably arranged on a side edge of the upper housing 21 to stop the blade 45. The safety spring 64 extends longitudinally along the axial direction and presses against the safety push button 61, so that when the blade holder 40 leaves the longitudinal position, a front end of the safety push button 61 is pressed against the blade holder 40 to avoid the blade 45, and when the blade holder 40 moves back to the longitudinal position, the safety push button 61 is reset to stop the blade 45. An engaging groove 612 is provided on an upper side of the safety push button 61. The engaging member 621 is arranged on the inner surface of the upper housing 21 and is configured to elastically and rotatably press against the drive member 30. The engaging member 621 is configured to detachably engage with the engaging groove 612. When the blade holder 40 is located in the longitudinal position, the engaging member 621 is configured to engage with the engaging groove 612, and the safety push button 61 avoids the blade 45 to allow the blade 45 to be rotated out of the accommodating cavity 23. When the blade holder 40 leaves the longitudinal position, the engaging member 621 is disengaged from the engaging groove 612 under an action of the drive member 30, so that the front end of the safety push button 61 presses against the blade holder 40.

Specifically, the safety push button 61 includes a base 611, a guide groove 613, a bent portion 614, and a stop portion 615. The guide groove 613 is provided on the base 611 to accommodate the safety spring 64 and is configured to engage with a guiding member 63, so that the base 611 is accommodated in the accommodating cavity 23 and is longitudinally movable along the guiding member 63. The engaging groove 612 and an elongated groove 617 are provided on an upper side of the base 611 and are spaced apart from each other. The engaging member 621 rotatably presses against the drive member 30 and is configured to move along the elongated groove 617 or engage with the engaging groove 612. The bent portion 614 extends in a bent configuration from the base 611 toward the outer side of the inner housing 20 and is exposed to the outer side of the inner housing 20, so that pushing of the bent portion 614 can cause the safety push button 61 to move along the guiding member 63. A slide groove 616 is formed between the base 611 and the bent portion 614 to be movably connected to the upper housing 21. The stop portion 615 extends from the base 611 toward the avoidance area 231 to cover at least a part of the avoidance area 231. When the blade 45 is located in the longitudinal position, the stop portion 615 is located below the blade 45 to stop the blade 45 from rotating out of the accommodating cavity 23. When the engaging member 621 is engaged with the engaging groove 612 or the front end of the safety push button 61 presses against the blade holder 40, the safety push button 61 is moved, so that the stop portion 615 avoids the blade 45 to allow the blade 45 to be rotated out of or into the accommodating cavity 23.

In a specific embodiment, the first guide member 411 and the second guide member 421 respectively arranged on the front side and the rear side of the blade holder 40 are located on an identical straight line parallel to the blade edge of the blade, a starting end of the first guide rail 212 and a starting end of the second guide rail 221 are located on an identical straight line parallel to the axis, the first guide rail 212 extends forward in a direction deviating from the second guide rail 221, the second guide rail 221 extends outward in a direction away from the first guide rail 212, and a terminal end of the first guide rail 212 and a terminal end of the second guide rail 221 are located on an identical straight line perpendicular to the axis. When the first guide member 411 is located at the starting end of the first guide rail 212 and the second guide member 421 is located at the starting end of the second guide rail 221, the blade holder 40 is located in the longitudinal position, and the blade 45 extends out of the end opening 24 to serve as a longitudinal cutter knife. When the first guide member 411 turns and moves along the first guide rail 212 and the second guide member 421 turns and moves along the second guide rail 221, the blade holder 40 is rotated out of the accommodating cavity 23 by a turning angle of substantially 0° to 90° or 90° to 180°. In this case, the blade 45 enters an oblique state. When the first guide member 411 is located at the terminal end of the first guide rail 212 and the second guide member 421 is located at the terminal end of the second guide rail 221, the blade holder 40 is rotated to the transverse position, and the blade 45 enters a transverse state to serve as a transverse scraper knife.

Specifically, as shown in FIG. 33, when the inner housing 20 is in an unfolded position, and the positioning portion 32 of the drive member 30 is located in the positioning region 2112 on the right side of the positioning slot 211 of the upper housing 21, the drive member 30 is located at a rightmost position. It can be understood that the sliding assembly 50 is also located at a rightmost position, the first guide member 411 of the blade holder 40 is connected to the first connecting hole 33 at the front end of the drive member 30, the first guide member 411 of the blade holder 40 is located at the end on an upper right side of the first guide rail 212, the second guide member 421 of the blade holder 40 is located at the end on a lower right side of the second guide rail 221, and the blade holder 40 is located in the longitudinal position, so that the blade edge of the blade 45 is parallel to the axis to serve as a cutter knife. In this case, the safety push button 61 is located at an initial position, i.e., a leftmost position, a first end of the engaging member 621 presses against the drive member 30, a second end of the engaging member 621 presses against the safety push button 61, the contact point is located on the right side of the elongated groove 617, and the stop portion 615 is located below the blade 45 to stop the blade 45 from rotating.

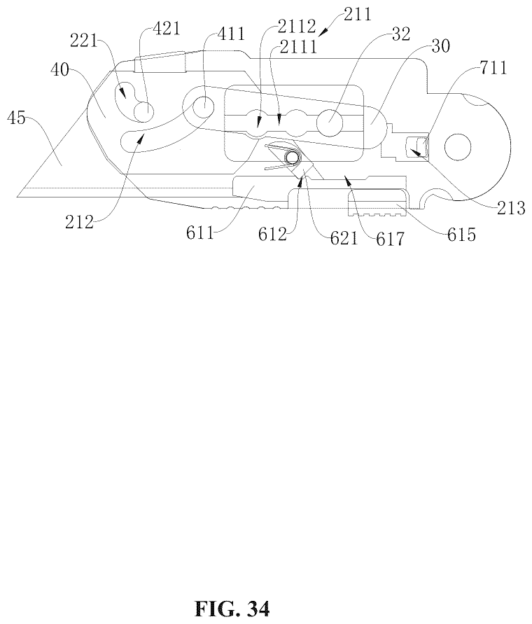

As shown in FIG. 34, the safety push button 61 is moved rightward. In this case, the first end of the engaging member 621 presses against the drive member 30, and the second end of the engaging member 621 presses against the safety push button 61 and is engaged with the engaging groove 612, so that the stop portion 615 deviates from the blade 45, and the blade holder 40 does not interfere with the blade 45 when driving the blade 45 to rotate.

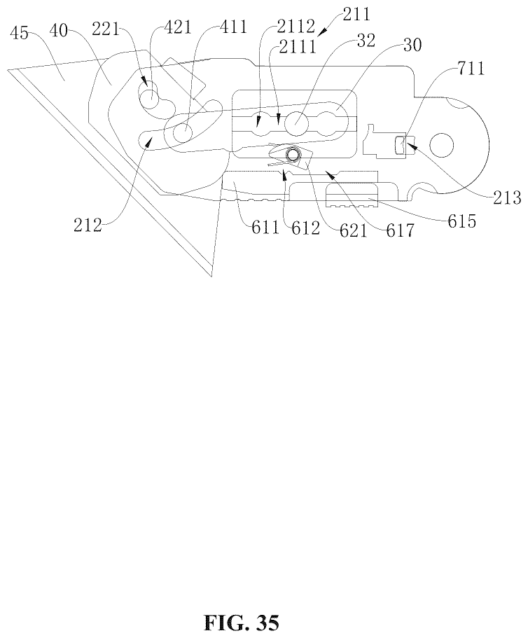

As shown in FIG. 35, the sliding assembly 50 is pressed, so that the positioning portion 32 of the drive member 30 is disengaged from the positioning region 2112 of the positioning slot 211 of the upper housing 21, and the engaging portion 511 of the sliding support 51 is engaged with the movement region 2111. The sliding assembly 50 can drive the drive member 30 to translate and/or rotate to further cause the first guide member 411 of the blade holder 40 to turn and move along the first guide rail 212 and cause the second guide member 421 of the blade holder 40 to turn and move along the second guide rail 221, so that the first guide member 411 moves to a middle part of the first guide rail 212 and the second guide member 421 moves to a middle part of the second guide rail 221. Then, the sliding assembly 50 is released. The sliding elastic piece 52 causes the sliding support 51 and the drive member 30 to move outward, and the positioning portion 32 of the drive member 30 is engaged with one of the positioning regions 2112 in a middle of the slide groove 616 of the upper housing 21 to lock the blade holder 40 in the transitional position. In this case, the blade edge of the blade 45 is completely exposed out of the inner housing 20 and forms an angle of 45° with the housing 10 for use as an oblique scraper knife.

It can be understood that when the drive member 30 moves and/or rotates, the engaging member 621 is driven by the drive member 30 to rotate counterclockwise in the direction shown in FIG. 35 to detach from the engaging groove 612, and further, an acting force of the safety spring 64 causes the safety push button 61 to move forward, so that the front end of the base 611 of the safety push button 61 presses against the blade holder 40, to prevent the safety push button 61 from being completely reset. In this case, the stop portion 615 still deviates from the blade 45 and therefore does not interfere with the blade 45, thereby ensuring that the blade holder 40 can drive the blade 45 to smoothly rotate.

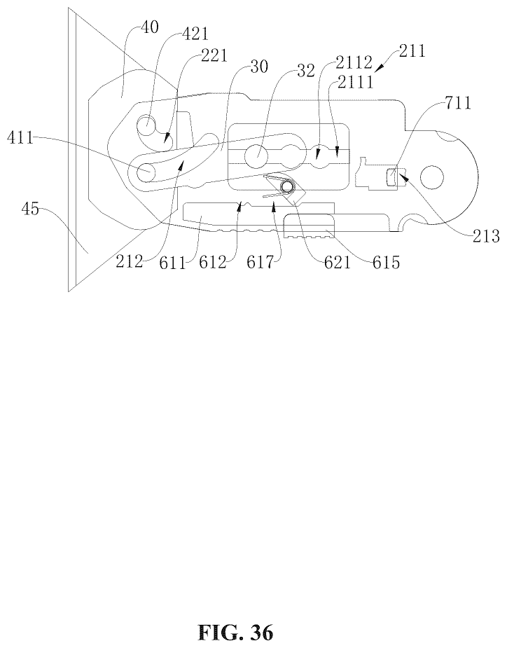

As shown in FIG. 36, the sliding assembly 50 is pressed, so that the positioning portion 32 of the drive member 30 is disengaged from the positioning region 2112 of the positioning slot 211 of the upper housing 21, and the engaging portion 511 of the sliding support 51 is engaged with the movement region 2111. The sliding assembly 50 can drive the drive member 30 to translate and/or rotate, to further cause the first guide member 411 of the blade holder 40 to turn and move along the first guide rail 212 and cause the second guide member 421 of the blade holder 40 to turn and move along the second guide rail 221, so that the first guide member 411 moves to the end on a lower left side of the first guide rail 212 and the second guide member 421 moves to the end on an upper left side of the second guide rail 221. Then, the sliding assembly 50 is released. The sliding elastic piece 52 causes the sliding support 51 and the drive member 30 to move outward, and the positioning portion 32 of the drive member 30 is engaged with one of the positioning regions 2112 on a left side of the slide groove 616 of the upper housing 21 to lock the blade holder 40 in the transverse position. In this case, the blade edge of the blade 45 is completely exposed out of the inner housing 20 and forms an angle of 90° with the housing 10 for use as a transverse scraper knife. It can be understood that by further extending the second guide rail 221, the blade holder 40 can continue to translate or rotate, so that the blade edge of the blade 45 forms an angle of 135°, or even 180°, or any other angle in the range of 90° to 180° with the inner housing 20.

It can be understood that when the drive member 30 translates and/or rotates, the acting force of the safety spring 64 causes the safety push button 61 to move forward, the front end of the base 611 of the safety push button 61 presses against the blade holder 40, and the engaging member 621 rotates clockwise in the direction shown in FIG. 36 under the action of an engaging spring 622. The first end of the engaging member 621 presses against the drive member 30, the second end of the engaging member 621 presses against the safety push button 61, and the contact point moves rightward along the elongated groove 617. In this case, the stop portion 615 still deviates from the blade 45 and therefore does not interfere with the blade 45, so that the blade holder 40 can drive the blade 45 to smoothly rotate. When the blade holder 40 is located in the longitudinal position, the safety push button 61 is completely reset, and the contact point between the engaging member 621 and the safety push button 61 is located at a rightmost position on the elongated groove 617.

Further, when the sliding assembly 50 is pressed to move rightward, the blade holder 40 is rotated from the transverse position to the longitudinal position through the transitional position, and the blade holder 40 presses against the front end of the base 611 of the safety push button 61. The rotation of the blade holder 40 causes the safety push button 61 to overcome resistance of the safety spring 64 and move rightward, so that the stop portion 615 does not interfere with the blade 45 to hinder the rotation of blade holder 40. In this case, the contact point between the engaging member 621 and the safety push button 61 moves leftward along the elongated groove 617. When the blade holder 40 approaches the longitudinal position, the blade holder 40 is separated from the safety push button 61, the acting force of the safety spring 64 causes the safety push button 61 to move forward and reset, the contact point between the engaging member 621 and the safety push button 61 is located at the rightmost position on the elongated groove 617, and the stop portion 615 is located below the blade 45 to stop the blade 45 from rotating.

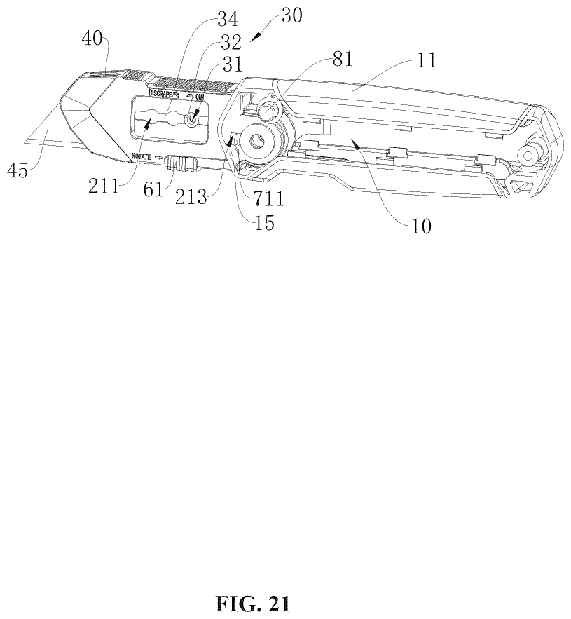

In some embodiments, as shown in FIG. 25, the multi-functional folding knife further includes a self-locking assembly 70. The self-locking assembly 70 includes a self-locking push button 71 and a self-locking spring 72. The self-locking push button 71 is longitudinally movably arranged on the inner housing 20 and is configured to press against the drive member 30. The self-locking spring 72 is configured to provide an acting force to the self-locking push button 71 for causing the self-locking push button 71 to move toward the drive member 30. As shown in FIG. 21, the self-locking push button 71 includes a first self-locking portion 711 protruding from the self-locking push button 71, the upper housing 21 is provided with a self-locking hole 213, the first self-locking portion 711 passes through the self-locking hole 213 and extends toward the outer housing 11, the outer housing 11 includes a second self-locking portion 15 protruding from an inner surface of the outer housing 11, and the drive member 30 acts on the self-locking push button 71, so that the first self-locking portion 711 detachably presses against the second self-locking portion 15.

Specifically, as shown in FIG. 21, FIG. 33, and FIG. 36, when the multi-functional folding knife is in the unfolded state, the second self-locking portion 15 on the outer housing 11 is located on a side of the self-locking hole 213 on the upper housing 21. As shown in FIG. 33, further, when the blade 45 is located in the longitudinal position, the drive member 30 presses against the self-locking push button 71, and the self-locking spring 72 is compressed, so that the self-locking push button 71 moves backward longitudinally along the axial direction, and further causes the first self-locking portion 711 to detach from the second self-locking portion 15, to allow the inner housing 20 to be rotated and folded into the main accommodating chamber 12 relative to the outer housing 11.

As shown in FIG. 35 and FIG. 36, when the blade 45 leaves the longitudinal position, the drive member 30 detaches from the self-locking push button 71, and the self-locking spring 72 pushes the self-locking push button 71 to move forward longitudinally along the axial direction and further cause the first self-locking portion 711 to press against the second self-locking portion 15, thereby preventing the inner housing 20 from rotating relative to the outer housing 11. As such, the multi-functional folding knife can be kept in the unfolded state to avoid an accidental injury caused by the blade 45 being unable to be smoothly accommodated in the main accommodating chamber 12.

It can be understood that when the blade 45 is located in the longitudinal position, the inner housing 20 rotates relative to the outer housing 11, and the blade 45 can be smoothly accommodated in the main accommodating chamber 12. When the blade 45 is located in the transitional position and the transverse position, the blade 45 interferes with the outer housing 11 and is likely to cause damage to the outer housing 11 or accidental injury to the user, even if the inner housing 20 can rotate relative to the outer housing 11. Through the configuration of the self-locking assembly 70, the inner housing 20 can be rotated and folded to the outer housing 11 when the blade holder 40 is located in the longitudinal position, and the multi-functional folding knife can be kept in the unfolded state when the blade holder 40 is located in other positions to avoid an accidental injury caused by the blade 45 being unable to be smoothly accommodated in the main accommodating chamber 12.

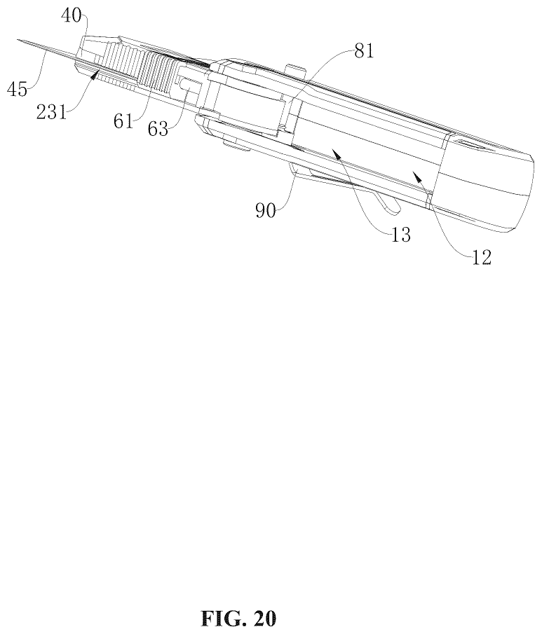

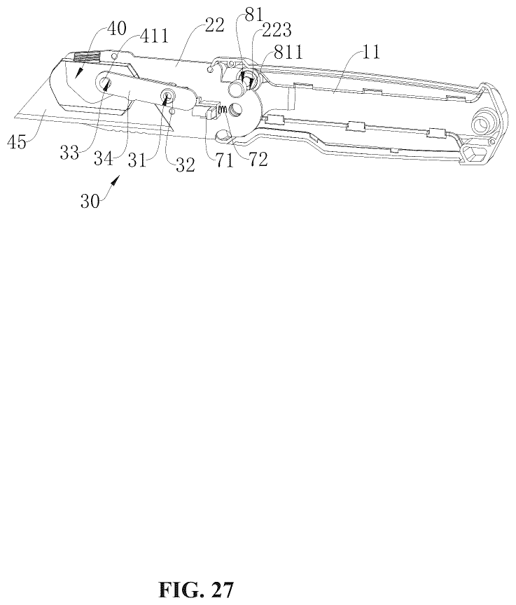

In some embodiments, as shown in FIG. 20, FIG. 27, and FIG. 28, the multi-functional folding knife further includes a locking assembly 80. The locking assembly 80 includes a locking member 81 and a locking spring 82. The locking member 81 is elastically and pressably connected to the outer housing 11 by the locking spring 82. The locking member 81 includes a locking portion 811 protruding radially. The inner housing 20 is provided with a plurality of locking notches 223. The locking portion 811 is detachably engaged with a locking notch 223 of the plurality of locking notches 223 to keep the inner housing 20 in an unfolded state or a folded state.

Specifically, the locking member 81 is pressed to compress the locking spring 82, so that the locking portion 811 is disengaged from a respective one of the locking notches 223, and the inner housing 20 can be rotated out of or into the main accommodating chamber 12 relative to the outer housing 11. Then, the locking member 81 is released. When the locking portion 811 is engaged with a respective one of the locking notches 223, the inner housing 20 is kept in the unfolded state or the folded state.

In a specific embodiment, the locking notches 223 are respectively provided on two sides of the lower housing 22, and when the locking portion 811 is engaged with a respective locking notch 223 on one side of the lower housing 22, the inner housing 20 is kept in the unfolded state. As such, the inner housing 20 can be prevented from rotating relative to the outer housing 11 to cause potential safety hazards during use, thereby facilitating a cutting or scraping operation. When the locking portion 811 is engaged with a respective locking notch 223 on the other side of the lower housing 22, the inner housing 20 is kept in the folded state. As such, the inner housing 20 can be prevented from rotating out of the main accommodating chamber 12 to expose the blade and cause potential safety hazards during storage or carrying.

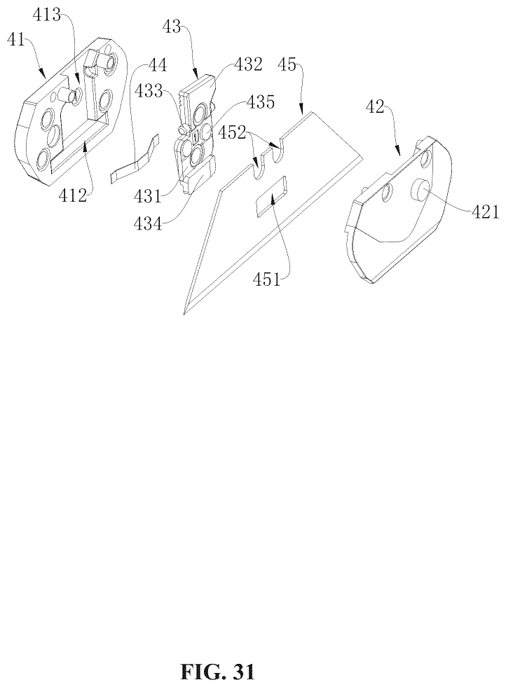

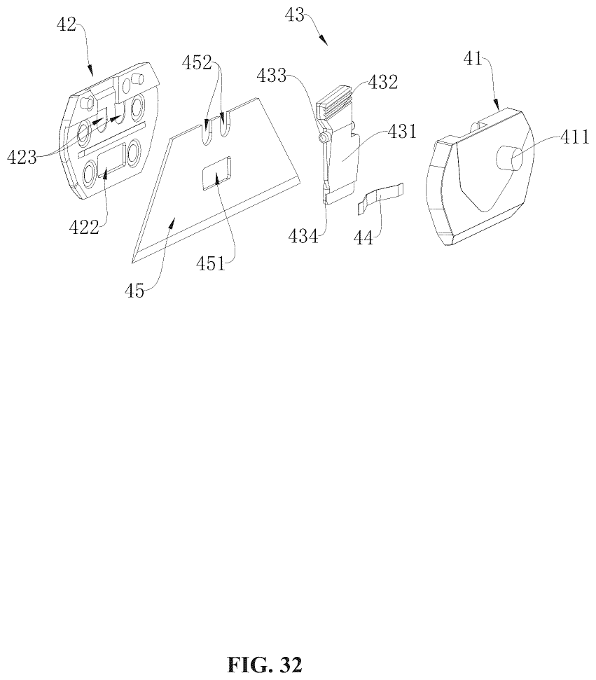

In some embodiments, as shown in FIG. 31 and FIG. 32, the blade holder 40 includes a first frame 41, a middle frame 43, a second frame 42, and a frame elastic piece 44. An elastic piece groove 412 and a first mounting groove 413 are provided on a side of the first frame 41 facing the second frame 42. The middle frame 43 is accommodated in the first mounting groove 413 and is rotatably connected to the first frame 41 and the second frame 42. The frame elastic piece 44 is accommodated in the elastic piece groove 412 to provide an acting force for pressing the middle frame 43 against the second frame 42, so that the blade 45 is detachably mounted between the second frame 42 and the middle frame 43 . . . . The first guide member 411 protrudes radially outward from the first frame 41, is pivotally connected to the first connecting hole 33 at the front end of the drive member 30, is connected to the first guide rail 212 on the inner side of the upper housing 21, and is driven by the drive member 30 to move along the first guide rail 212. The second guide member 421 protrudes radially outward from the second frame 42 eccentrically with respect to the first guide member 411 and is connected to the second guide rail 221 of the lower housing 22.

Specifically, the middle frame 43 includes a main body 431, a shaft portion 433, and an extension portion 432. The shaft portion 433 is located on two sides of an upper end of the main body 431 and is rotatably connected to the first frame 41. The extension portion 432 extends upward from the upper end of the main body 431, is exposed to outside from an upper end of the blade holder 40, and is movably located between the first frame 41 and the second frame 42. Further, a limiting portion 435 and a fixing portion 434 are arranged on and protrude from a side of a lower end of the main body 431 facing the second frame 42. The blade 45 includes a limiting notch 452 and a mounting hole 451, and the limiting notch 452 and the mounting hole 451 extend through the blade 45. The limiting portion 435 on the main body 431 is configured to engage with the limiting notch 452. The fixing portion 434 is configured to pass through the mounting hole 451 to fix the blade 45. A second mounting groove 422 and a third mounting groove 423 are provided on a side of the second frame 42 facing the middle frame 43. The second mounting groove 422 is configured to accommodate an end of the fixing portion 434. The third mounting groove 423 is configured to avoid an end of the limiting portion 435.

It can be understood that the extension portion 432 and the main body 431 are respectively located on two sides of a central axis of the shaft portion 433, and the extension portion 432 is pulled to overcome an elastic force of the frame elastic piece 44 and cause the main body 431 to rotate away from the second frame 42 to further cause the fixing portion 434 at the lower end of the main body 431 to separate from the mounting hole 451 for replacing the blade 45. In a specific embodiment, a thickness of the main body 431 gradually decreases from top to bottom, making the structure of the blade holder 40 more compact, thereby reducing the volume of the blade holder 40.

In some embodiments, as shown in FIG. 20 and FIG. 25, the multi-functional folding knife further includes a clip 90. The clip 90 is elastically arranged on an outer side surface of the outer housing 11 to clip the multi-functional folding knife to an object, such as a notebook, a pocket, etc., to avoid loss of the knife.

The basic principles, main features and advantages of the present disclosure have been described above. Those skilled in the art should understand that the present disclosure is not limited to the above-mentioned embodiments. The descriptions of the embodiments and the specification are only for illustrating the principles of the present disclosure. Various changes and improvements may be made to the present disclosure without departing from the spirit and scope of the present disclosure, and such changes and improvements all fall within the scope of protection claimed by the present disclosure. The scope of protection claimed by the present disclosure is defined by the appended claims and equivalents thereof.

What is claimed is:

1-10. (canceled)

11. A multi-functional folding knife, comprising:
a housing, wherein the housing comprises an outer housing and an inner housing, the inner housing is rotatably and foldably mounted in the outer housing, the inner housing is provided with an accommodating cavity and an end opening, and the end opening is provided at a front end of the inner housing;
a blade holder, wherein the blade holder is configured to hold a blade, and is rotatably mounted in the accommodating cavity;
a first guide assembly, wherein the first guide assembly comprises a first guide rail and a drive member, and the drive member is drivably connected to a front side of the blade holder to cause the blade holder to move along the first guide rail; and the drive member is provided with a driver surface
a second guide assembly, wherein the second guide assembly comprises a fixed surface and a second guide rail provided on the fixed surface, and a rear side of the blade holder is pivotally connected to the second guide rail to cause the blade holder to move along the second guide rail, and when the drive member translates and/or rotates relative to the fixed surface, the blade holder is selectively rotated into or out of the accommodating cavity, so that an orientation of the blade holder is changed to a plurality of positioning angles between a longitudinal position and a transverse position alternately; and wherein the blade holder comprises a first guide member and a second guide member, the first guide member and the second guide member are respectively arranged on the front side and the rear side of the blade holder in a staggered manner, the first guide member protrudes from the front side of the blade holder and is pivotally connected to a front end of the driving surface and the first guide rail to drive the blade holder to translate and/or rotate along the first guide rail, and the second guide member protrudes from the rear side of the blade holder and is pivotally connected to the second guide rail to drive the blade holder to translate and/or rotate along the second guide rail, so that a longitudinal driving force applied by the sliding assembly to the drive member is converted to a force applied by the drive member to turn the blade holder to the plurality of positioning angles.

12. (canceled)

13. The multi-functional folding knife according to claim 11, wherein the first guide rail and the second guide rail are respectively of arc-shaped structures with different trajectories, the first guide rail extends forward in a direction deviating from the second guide rail, and the second guide rail extends outward in a direction deviating from the first guide rail, so that the blade holder is connected to the fixed surface and the driving surface in two different directions; and when the blade holder is gradually turned under acting forces from the fixed surface and the driving surface, the blade holder is gradually rotated out of or back into the accommodating cavity through the end opening, so that an orientation of the blade on the blade holder is changed to the plurality of positioning angles between the longitudinal position and the transverse position.

14. The multi-functional folding knife according to claim 13, wherein the first guide member and the second guide member respectively arranged on the front side and the rear side of the blade holder are located on an identical straight line parallel to a blade edge of the blade, a starting end of the first guide rail and a starting end of the second guide rail are located on an identical straight line parallel to an axis, the first guide rail extends forward in a direction deviating from the second guide rail, the second guide rail extends outward in a direction away from the first guide rail, and a terminal end of the first guide rail and a terminal end of the second guide rail are located on an identical straight line perpendicular to the axis; when the first guide member is located at the starting end of the first guide rail and the second guide member is located at the starting end of the second guide rail, the blade holder is located in the longitudinal position, and the blade extends out of the end opening to serve as a longitudinal cutter knife; when the first guide member turns and moves along the first guide rail and the second guide member turns and moves along the second guide rail, the blade holder is rotated out of the accommodating cavity by a turning angle of substantially 0° to 90° or 90° to 180°, and the blade enters an oblique state; and when the first guide member is located at the terminal end of the first guide rail and the second guide member is located at the terminal end of the second guide rail, the blade holder is rotated to the transverse position, and the blade enters a transverse state to serve as a transverse scraper knife.

15. The multi-functional folding knife according to claim 13, wherein the inner housing comprises an upper housing and a lower housing, the drive member is accommodated in the accommodating cavity between the upper housing and the lower housing and is located between the upper housing and the blade holder, the upper housing is provided with the first guide rail and a positioning slot, the first guide rail is formed on an inner surface of the upper housing, the positioning slot is formed on a surface of the upper housing, the fixed surface is located on a surface of the lower housing, the second guide rail is formed on the surface of the lower housing, the blade holder is movably connected to the upper housing and the lower housing by the first guide member and the second guide member, a lower end of the sliding assembly passes through the positioning slot and is connected to a rear end of the drive member to drive the drive member to cause the blade holder to translate and/or rotate, and the drive member is configured to be elastically locked in the positioning slot to lock the blade on the blade holder in the longitudinal position, the transverse position, or a transitional position between the longitudinal position and the transverse position.

16. The multi-functional folding knife according to claim 15, further comprising a safety assembly, wherein the safety assembly comprises a safety push button, a safety spring, and an engaging member, the safety push button is longitudinally movably arranged on a side edge of the upper housing to stop the blade, and the safety spring extends longitudinally along an axial direction and presses against the safety push button, so that when the blade holder leaves the longitudinal position, a front end of the safety push button is pressed against the blade holder to avoid the blade, and when the blade holder moves back to the longitudinal position, the safety push button is reset to stop the blade; an engaging groove is provided on an upper side of the safety push button, the engaging member is arranged on the inner surface of the upper housing and is configured to elastically and rotatably press against the drive member, and the engaging member is configured to detachably engage with the engaging groove; when the blade holder is located in the longitudinal position, the engaging member is configured to engage with the engaging groove, and the safety push button avoids the blade to allow the blade to be rotated out of the accommodating cavity; and when the blade holder leaves the longitudinal position, the engaging member is disengaged from the engaging groove under an action of the drive member, so that the front end of the safety push button presses against the blade holder.

17. The multi-functional folding knife according to claim 16, further comprising a self-locking assembly, wherein the self-locking assembly comprises a self-locking push button and a self-locking spring, the self-locking push button is longitudinally movably arranged on the inner housing and is configured to press against the drive member, the self-locking spring is configured to provide an acting force to the self-locking push button for causing the self-locking push button to move toward the drive member, the self-locking push button comprises a first self-locking portion protruding from the self-locking push button, the upper housing is provided with a self-locking hole, the first self-locking portion passes through the self-locking hole and extends toward the outer housing, and the outer housing comprises a second self-locking portion protruding from an inner surface of the outer housing; when the multi-functional folding knife is in an unfolded state, the second self-locking portion is located on a side of the self-locking hole; when the blade leaves the longitudinal position, the first self-locking portion presses against the second self-locking portion, so that the multi-functional folding knife is kept in the unfolded state; and when the blade is located in the longitudinal position, the drive member pushes the self-locking push button to cause the first self-locking portion to detach from the second self-locking portion to allow the inner housing to be rotated and folded relative to the outer housing.

18. The multi-functional folding knife according to claim 16 wherein the blade holder comprises a first frame, a middle frame, a second frame, and a frame elastic piece, the middle frame is rotatably connected to the first frame and the second frame, and the frame elastic piece is configured to provide an acting force for pressing the middle frame against the second frame, so that the blade is detachably mounted between the second frame and the middle frame; the first guide member protrudes radially outward from the first frame, and the second guide member protrudes radially outward from the second frame eccentrically with respect to the first guide member; and
the middle frame comprises a main body, a shaft portion located on two sides of the main body, and an extension portion located at an upper end of the main body, the extension portion and the main body are respectively located on two sides of a central axis of the shaft portion, the extension portion is exposed to an outside from an upper end of the blade holder and is movably located between the first frame and the second frame, and the extension portion is pulled to overcome an elastic force of the frame elastic piece and cause the main body to rotate away from the second frame for replacing the blade.

19. The multi-functional folding knife according to claim 18, further comprising a locking assembly, wherein the locking assembly comprises a locking member and a locking spring, the locking member is elastically and pressably connected to the outer housing, the locking member comprises a locking portion protruding radially, the inner housing is provided with a plurality of locking notches, and the locking portion is detachably engaged with a locking notch of the plurality of locking notches to keep the inner housing in an unfolded state or a folded state.

20. The multi-functional folding knife according to claim 19, wherein
an elastic piece groove for mounting the frame elastic piece and a first mounting groove for accommodating the middle frame are provided on a side of the first frame facing the second frame, the blade comprises a limiting notch and a mounting hole, the limiting notch and the mounting hole extend through the blade, a limiting portion and a fixing portion are arranged on and protrude from a side of the main body facing the second frame, the limiting portion is configured to engage with the limiting notch, the fixing portion is configured to pass through the mounting hole to fix the blade, a second mounting groove and a third mounting groove are provided on a side of the second frame facing the middle frame, the second mounting groove is configured to accommodate an end of the fixing portion, the third mounting groove is configured to avoid an end of the limiting portion, and the extension portion is pulled to separate the fixing portion from the mounting hole;
the sliding assembly comprises a sliding support and a sliding elastic piece, the sliding support passes through the positioning slot and is connected to the drive member, and the sliding elastic piece is connected to the sliding support and abuts between the drive member and the lower housing, so that the drive member is movably locked in the positioning slot; a sliding panel is arranged on an end of the sliding support extending out of an outer side of the inner housing to push the sliding assembly to move along the positioning slot;
the positioning slot comprises a movement region and a plurality of positioning regions, the movement region is elongated and extends longitudinally along the axial direction and the plurality of positioning regions are distributed at intervals, an engaging portion is arranged on a side of the sliding support facing the drive member and is elongated, the engaging portion is configured to move along the movement region of the positioning slot, a positioning portion is arranged on and protrudes from a side of the drive member facing the positioning slot, and the positioning portion is configured to engage with a positioning region of the plurality of positioning regions to lock the drive member;
the drive member comprises a first connecting hole and a second connecting hole, the first connecting hole is configured to be connected to the first guide member on the first frame, the second connecting hole is configured to be connected to the sliding assembly, and when the sliding assembly is pushed, the blade holder is pushed to move by the drive member;
the inner housing is provided with an avoidance area, the avoidance area is located at one side or two sides of the front end of the inner housing, the accommodating cavity is in lateral communication with the outside through the avoidance area, and when the blade holder rotates, the avoidance area allows the blade holder to rotate out of or into the accommodating cavity;
the safety assembly further comprises a guiding member, the guiding member is fixed to the inner housing, the safety push button comprises a base, a guide groove, a bent portion, and a stop portion, the base is longitudinally movably accommodated in the accommodating cavity, the guide groove is provided on the base to accommodate the safety spring and is configured to engage with the guiding member to cause the base to move longitudinally, the engaging groove and an elongated groove are provided on an upper side of the base and are spaced apart from each other, the engaging member rotatably presses against the drive member under an action of an engaging spring and is configured to move along the elongated groove or engage with the engaging groove, the bent portion extends in a bent configuration from the base toward the outer side of the inner housing and is exposed to the outer side of the inner housing, a slide groove is formed between the base and the bent portion to be movably connected to the inner housing, the stop portion extends from the base toward the avoidance area to cover at least a part of the avoidance area, and when the blade is located in the longitudinal position, the stop portion is located below the blade to stop the blade from rotating out of the accommodating cavity; and
the multi-functional folding knife further comprises a clip, and the clip is elastically arranged on an outer side surface of the outer housing to clip the multi-functional folding knife to an object.

21. The multi-functional folding knife according to claim 17, wherein the blade holder comprises a first frame, a middle frame, a second frame, and a frame elastic piece, the middle frame is rotatably connected to the first frame and the second frame, and the frame elastic piece is configured to provide an acting force for pressing the middle frame against the second frame, so that the blade is detachably mounted between the second frame and the middle frame; the first guide member protrudes radially outward from the first frame, and the second guide member protrudes radially outward from the second frame eccentrically with respect to the first guide member; and
the middle frame comprises a main body, a shaft portion located on two sides of the main body, and an extension portion located at an upper end of the main body, the extension portion and the main body are respectively located on two sides of a central axis of the shaft portion, the extension portion is exposed to an outside from an upper end of the blade holder and is movably located between the first frame and the second frame, and the extension portion is pulled to overcome an elastic force of the frame elastic piece and cause the main body to rotate away from the second frame for replacing the blade.

22. The multi-functional folding knife according to claim 21, further comprising a locking assembly, wherein the locking assembly comprises a locking member and a locking spring, the locking member is elastically and pressably connected to the outer housing, the locking member comprises a locking portion protruding radially, the inner housing is provided with a plurality of locking notches, and the locking portion is detachably engaged with a locking notch of the plurality of locking notches to keep the inner housing in an unfolded state or a folded state.

23. The multi-functional folding knife according to claim 22, wherein
an elastic piece groove for mounting the frame elastic piece and a first mounting groove for accommodating the middle frame are provided on a side of the first frame facing the second frame, the blade comprises a limiting notch and a mounting hole, the limiting notch and the mounting hole extend through the blade, a limiting portion and a fixing portion are arranged on and protrude from a side of the main body facing the second frame, the limiting portion is configured to engage with the limiting notch, the fixing portion is configured to pass through the mounting hole to fix the blade, a second mounting groove and a third mounting groove are provided on a side of the second frame facing the middle frame, the second mounting groove is configured to accommodate an end of the fixing portion, the third mounting groove is configured to avoid an end of the limiting portion, and the extension portion is pulled to separate the fixing portion from the mounting hole;
the sliding assembly comprises a sliding support and a sliding elastic piece, the sliding support passes through the positioning slot and is connected to the drive member, and the sliding elastic piece is connected to the sliding support and abuts between the drive member and the lower housing, so that the drive member is movably locked in the positioning slot; a sliding panel is arranged on an end of the sliding support extending out of an outer side of the inner housing to push the sliding assembly to move along the positioning slot;
the positioning slot comprises a movement region and a plurality of positioning regions, the movement region is elongated and extends longitudinally along the axial direction and the plurality of positioning regions are distributed at intervals, an engaging portion is arranged on a side of the sliding support facing the drive member and is elongated, the engaging portion is configured to move along the movement region of the positioning slot, a positioning portion is arranged on and protrudes from a side of the drive member facing the positioning slot, and the positioning portion is configured to engage with a positioning region of the plurality of positioning regions to lock the drive member;
the drive member comprises a first connecting hole and a second connecting hole, the first connecting hole is configured to be connected to the first guide member on the first frame, the second connecting hole is configured to be connected to the sliding assembly, and when the sliding assembly is pushed, the blade holder is pushed to move by the drive member;
the inner housing is provided with an avoidance area, the avoidance area is located at one side or two sides of the front end of the inner housing, the accommodating cavity is in lateral communication with the outside through the avoidance area, and when the blade holder rotates, the avoidance area allows the blade holder to rotate out of or into the accommodating cavity;
the safety assembly further comprises a guiding member, the guiding member is fixed to the inner housing, the safety push button comprises a base, a guide groove, a bent portion, and a stop portion, the base is longitudinally movably accommodated in the accommodating cavity, the guide groove is provided on the base to accommodate the safety spring and is configured to engage with the guiding member to cause the base to move longitudinally, the engaging groove and an elongated groove are provided on an upper side of the base and are spaced apart from each other, the engaging member rotatably presses against the drive member under an action of an engaging spring and is configured to move along the elongated groove or engage with the engaging groove, the bent portion extends in a bent configuration from the base toward the outer side of the inner housing and is exposed to the outer side of the inner housing, a slide groove is formed between the base and the bent portion to be movably connected to the inner housing, the stop portion extends from the base toward the avoidance area to cover at least a part of the avoidance area, and when the blade is located in the longitudinal position, the stop portion is located below the blade to stop the blade from rotating out of the accommodating cavity; and
the multi-functional folding knife further comprises a clip, and the clip is elastically arranged on an outer side surface of the outer housing to clip the multi-functional folding knife to an object.
